(19) United States
(12) Patent Application Publication
(10) Pub. No.: US 2005/0030931 A1
(43) Pub. Date: Feb. 10, 2005

(54) Apparatus and method for modulating ranging signals in a broadband wireless access communication system

(75) Inventors: Sang-Hoon Sung, Suwon-si (KR); Bong-Gee Song, Seoul (KR); Soon-Young Yoon, Seongnam-si (KR); Kwang-Seop Eom, Seongnam-si (KR); In-Seok Hwang, Seoul (KR); Jae-Hee Cho, Seoul (KR); Hoon Huh, Seongnam-si (KR); Kwan-Hee Roh, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/909,463

(22) Filed: Aug. 2, 2004

(30) Foreign Application Priority Data
Aug. 4, 2003 (KR) P2003-53799

(51) Int. Cl. H04B 7/216

(52) U.S. Cl. 370/342; 370/335

(57) ABSTRACT

An method and apparatus for transmitting ranging information from at least one base station to subscriber stations and generating a ranging signal by the subscriber station using received ranging information in a Broadband Wireless Access (BWA) communication system including a plurality of neighbor cells and a plurality of the subscriber stations located in each cell region. A first code generator generates a first code using different first code information received from the base stations in the neighbor cells allocated the first code information. A second code generator generates a second code using second code information received by each of the subscriber stations existing in cell regions of the neighbor cells. A ranging signal generator generates a new ranging signal by combining the first code with the second code.

### PRIORITY

This application claims priority under 35 U.S.C. § 119 to an application entitled “Apparatus and Method for Modulating Ranging Signals in a Broadband Wireless Access Communication System” filed in the Korean Intellectual Property Office on Aug. 4, 2003 and assigned Serial No. 2003-53799, the contents of which are incorporated herein by reference.

### BACKGROUND OF THE INVENTION

1. Field of the Invention

The present invention relates generally to a Broadband Wireless Access (BWA) communication system, and in particular, to an apparatus and method for modulating ranging signals in a BWA communication system supporting Orthogonal Frequency Division Multiplexing (OFDM).

2. Description of the Related Art

In a 4^{th} generation (4G) communication system, which is a next generation communication system, research is actively being conducted on technologies for providing users with various qualities of service (QoSs) at a data rate of about 100 Mbps. The current 3^{rd} generation (3G) communication system supports a data rate of about 384 Kbps in an outdoor channel environment having a relatively poor channel environment, and supports a data rate of a maximum of 2 Mbps in an indoor channel environment having a relatively good channel environment.

A wireless local area network (LAN) system and a wireless metropolitan area network (MAN) system support a data rate of 20 to 50 Mbps. Therefore, in the current 4G communication system, research is actively being carried out on a new communication system securing mobility and QoS for the wireless LAN system and the wireless MAN system supporting a relatively high data rate, in order to support the high-speed services that the 4G communication system intends to provide.

A communication system proposed in Institute of Electrical and Electronics Engineers (IEEE) 802.16a performs a ranging operation between a subscriber station (SS) and a base station (BS), for communication. FIG. 1 is a diagram schematically illustrating a configuration of an Orthogonal Frequency Division Multiplexing/Orthogonal Frequency Division Multiple Access (OFDM/OFDMA) Broadband Wireless Access (BWA) communication system. More specifically, FIG. 1 illustrates a configuration of an IEEE 802.16a/IEEE 802.16e communication system.

However, before a description of FIG. 1 is given, in the description, it is presumed that the wireless MAN system is a BWA communication system, and is broader in service area and higher in data rate than the wireless LAN system. A communication system utilizing OFDM/OFDMA to support a broadband transmission network for a physical channel of the wireless MAN system is called an “IEEE 802.16a OFDM/OFDMA communication system.” That is, an IEEE 802.16a communication system corresponds to the OFDM/OFDMA BWA communication system.

The IEEE 802.16a communication system enables high-speed data transmission by transmitting a physical channel signal using multiple subcarriers. In addition, the IEEE 802.16e communication system is a communication system that considers mobility of a subscriber station in the IEEE 802.16a communication system. Currently, no specification for the IEEE 802.16e communication system has been provided. Therefore, both the IEEE 802.16a communication system and the IEEE 802.16e communication system correspond to the OFDM/OFDMA BWA communication system, and for the convenience of explanation, the IEEE 802.16a and IEEE 802.16e OFDM/OFDMA communication systems will be described herein below. Although the IEEE 802.16a communication system and the IEEE 802.16e communication system can utilize a Single Carrier instead of OFDM/OFDMA, it will be assumed herein that OFDM/OFDMA is used.

Referring to FIG. 1, the IEEE 802.16a/IEEE 802.16e communication system has a multicell configuration, and includes a base station 100 and a plurality of subscriber stations 110, 120, and 130, all of which are managed by the base station 110. Signal exchange between the base station 110 and the subscriber stations 110, 120, and 130 is accomplished using OFDM/OFDMA.

OFDMA can be defined as a two-dimensional access method, which is a combination of Time Division Access (TDA) and Frequency Division Access (FDA). Therefore, when data is transmitted by OFDMA, OFDMA symbols are separately carried by subcarriers and transmitted over predetermined subchannels. The “subchannel” is a channel including a plurality of subcarriers, and in a communication system supporting OFDMA, i.e., an OFDMA communication system, each subchannel includes a predetermined number of subcarriers according to system conditions.

FIG. 2 is a diagram schematically illustrating a frame configuration of an OFDMA communication system. Referring to FIG. 2, a horizontal axis represents OFDMA symbol numbers, and a vertical axis represents subchannel numbers. One OFDMA frame includes a plurality of OFDMA symbols, e.g., 8, and each OFDMA symbol includes a plurality of subchannels, e.g., N. Further, each OFDMA frame includes a plurality of ranging slots, e.g., 4. Reference numeral 201 represents ranging regions, or ranging slots, in an M^{th} frame, and reference numeral 202 represents ranging slots in an (M+1)^{th} frame.

A ranging channel includes at least one subchannel. Unique numbers of the subchannels included in the ranging channel are included in an uplink (UL)-MAP message. The ranging channel is a logical channel using ranging regions in a frame, and Initial Ranging, Periodic Ranging, and Bandwidth Request Ranging are performed through the ranging channel. The ranging slots are provided by dividing the ranging channel in a time axis, and are classified into initial ranging slots, periodic ranging slots, and bandwidth request ranging slots.

The UL-MAP message is a message representing uplink frame information, and includes an ‘Uplink Channel ID’ representing an uplink channel identifier (ID) in use, a ‘UCD Count’ representing a count corresponding to a change in configuration of an Uplink Channel Descript (UCD) message having an uplink burst profile, and a ‘Number of UL-MAP Elements n’ representing the number of elements following the UCD Count. The uplink channel identifier is uniquely allocated in a Media Access Control (MAC) sublayer. That is, the OFDMA communication system attempts to distribute all subcarriers used therein, in particular, data subcarriers over the entire frequency band, to thereby acquire frequency diversity gain.

In addition, the OFDMA communication system needs a ranging process for adjusting a correct time offset to a transmission side, or a base station, and a reception side, or a subscriber station, and controlling power.

FIG. 3 is a diagram schematically illustrating a downlink frame configuration for an OFDM/OFDMA BWA communication system, particularly, illustrating a downlink frame configuration for an IEEE 802.16a/IEEE 802.16e communication system. Referring to FIG. 3, a downlink frame 300 includes a preamble field 310, a Frame Control Header (FCH) field 320, and a plurality of DL burst fields (DL burst #1 to DL burst #m) 330 to 340. The preamble field 310 transmits a synchronization signal, or a preamble sequence, for synchronizing a base station and a subscriber station.

The FCH field 320 includes a DL Frame Prefix field 321, a field 323 including a Downlink Channel Descript (DCD), a UCD, and MAPs, and a padding field 325. The MAPs include a downlink (DL)-MAP having information on a downlink frame and UL-MAP having information on an uplink frame.

The DL-MAP field is a field in which a DL-MAP message is transmitted. Information Elements (IEs) included in the DL-MAP message are shown in Table 1 below.

TABLE 1

| Syntax | Size | Notes |
|---|---|---|
| DL-MAP_Message_Format( ) { | | |
| Management Message Type = 2 | 8 bits | |
| PHY Synchronization Field | Variable | See appropriate PHY specification. |
| DCD Count | 8 bits | |
| Base Station ID | 48 bits | |
| Number of DL-MAP Elements n | 16 bits | |
| Begin PHY Specific Section { | | See applicable PHY section. |
| for (i = 1; i <= n; i++) { | | For each DL-MAP element 1 to n. |
| DL_MAP_Information_Element( ) | Variable | See corresponding PHY specification. |
| if !(byte boundary) { | | |
| Padding Nibble | 4 bits | Padding to reach byte boundary. |
| } | | |
| } | | |
| } | | |
| } | | |

As illustrated in Table 1, a DL-MAP message includes a plurality of IEs of ‘Management Message Type’ representing a type of a transmission message, a ‘PHY Synchronization Field’ being set according to a modulation scheme and a demodulation scheme employed for a physical (PHY) channel for acquiring synchronization, a ‘DCD Count’ representing a count corresponding to a change in configuration of a message including a downlink burst profile, a ‘Base Station ID’ representing a Base Station Identifier (BSID), and a ‘Number of DL-MAP Elements n’ representing the number of elements following the Base Station ID. Although not illustrated in Table 1, the DL-MAP message includes information on ranging codes allocated separately to rangings described herein below.

The UL-MAP field is a field in which a UL-MAP message is transmitted. IEs included in the UL-MAP message are shown in Table 2.

TABLE 2

| Syntax | Size |
|---|---|
| UL_MAP_Message_Format( ) { | |
| Management Message Type=3 | 8 bits |
| Uplink channel ID | 8 bits |
| UCD Count | 8 bits |
| Number of UL_MAP Elements n | 16 bits |
| Allocation Start Time | 32 bits |
| Begin PHY Specific Section { | |
| for(i=1; i<n; i+n) | |
| UL_MAP_Information_Element { | Variable |
| Connection ID | |
| UIUC | |
| Offset | |
| } | |
| } | |
| } | |
| } | |

As shown in Table 2, a UL-MAP message includes a plurality of IEs such as a ‘Management Message Type’ representing a type of a transmission message, an ‘Uplink Channel ID’ representing an uplink channel ID in use, a ‘UCD Count’ representing a count corresponding to a change in configuration of a UCD message having an uplink burst profile, and a ‘Number of UL-MAP Elements n’ representing the number of elements following the UCD Count. The uplink channel identifier is uniquely allocated in a MAC sublayer.

In Table 2, an Uplink Interval Usage Code (UIUC) field records therein information for designating a usage of an offset recorded in an Offset field. For example, if ‘2’ is recorded in the UIUC field, it indicates that a Starting offset used for initial ranging is recorded in the Offset field. If ‘3’ is recorded in the UIUC field, it indicates that a Starting offset used for bandwidth request ranging or maintenance ranging is recorded in the Offset field. The Offset field, as described above, records therein a time offset value used for initial ranging and bandwidth request ranging or maintenance ranging based on the information recorded in the UIUC field. In addition, information on a characteristic of a physical channel to be transmitted in the UIUC field is recorded in the UCD message.

If the subscriber station has failed to perform successful ranging, it determines a particular backoff value in order to increase success probability at a next attempt, and makes another ranging attempt after a lapse of the backoff time. Information necessary for determining the backoff value is also included in the UCD message. A configuration of the UCD message will be described in detail herein below with reference to Table 3.

TABLE 3

| Syntax | Size | Notes |
|---|---|---|
| UCD-Message_Format( ) { | | |
| Management Message Type=0 | 8 bits | |
| Uplink channel ID | 8 bits | |
| Configuration Change Count | 8 bits | |
| Mini-slot size | 8 bits | |
| Ranging Backoff Start | 8 bits | |
| Ranging Backoff End | 8 bits | |
| Request Backoff Start | 8 bits | |
| Request Backoff End | 8 bits | |
| TLV Encoded Information for the overall channel | Variable | |
| Begin PHY Specific Section { | | |
| for(i=1; i<n; i+n) | | |
| Uplink_Burst_Descriptor | Variable | |
| } | | |
| } | | |
| } | | |

As illustrated in Table 3, the UCD message includes a plurality of IEs such as a ‘Management Message Type’ representing a type of a transmission message, an ‘Uplink Channel ID’ representing an uplink channel ID in use, a ‘Configuration Change Count’ counted in a base station, a ‘Mini-slot Size’ representing a size of mini-slots in an uplink physical channel, a ‘Ranging Backoff Start’ representing a start point of a backoff for initial ranging, i.e., representing a size of an initial backoff window for initial ranging, a ‘Ranging Backoff End’ representing an end point of a backoff for initial ranging, i.e., representing a size of a final backoff window, a ‘Request Backoff Start’ representing a start point of a backoff for contention data and requests, i.e., representing a size of a first backoff window, and a ‘Request Backoff End’ representing an end point of a backoff for contention data and requests, i.e., representing a size of a final backoff window.

The backoff value represents a kind of a waiting time during which a subscriber station should wait for a next ranging when it has failed in ranging. When the subscriber station fails in ranging, the base station must transmit the backoff value to the subscriber station, which is information on a time for which it must wait for a next ranging.

In addition, the DL burst fields 330 to 340 correspond to time slots uniquely allocated to subscriber stations by TDM/TDMA (Time Division Multiple Access). The base station transmits broadcasting information to be broadcasted to subscriber stations managed by the base station through a DL-MAP field of the downlink frame using a center carrier.

At a power-on, the subscriber stations monitor all frequency bands that are previously and uniquely set thereto, and detect a pilot channel signal having a highest power, e.g., a highest carrier to interference and noise ratio (CINR). A subscriber station determines a base station that transmitted a pilot channel signal having the highest CINR as its base station to which it currently belongs, and detects control information for controlling its uplink and downlink and information representing actual data transmission/reception points by analyzing a DL-MAP field and a UL-MAP field of the downlink frame transmitted by the base station.

FIG. 4 is a diagram schematically illustrating a configuration of an uplink frame for an OFDM/OFDMA BWA communication system, particularly, illustrating an uplink frame configuration for an IEEE 802.16a/IEEE 802.16e communication system. However, before a description of FIG. 4 is given, a description will be made of rangings used in the IEEE 802.16a/IEEE 802.16e communication system, i.e., an Initial Ranging, a Maintenance Ranging (or a Periodic Ranging), and a Bandwidth Request Ranging.

1. Initial Ranging

The initial ranging synchronizes a subscriber station and a base station at the request of the base station. More specifically, the initial ranging adjusts a correct time offset between the subscriber station and the base station and controls transmission power. That is, the subscriber station receives a DL-MAP message and a UL-MAP/UCD message upon power-on to acquire synchronization with the base station, and then performs the initial ranging in order to adjust the time offset with the base station and transmission power. The base station receives a MAC address of the subscriber station from the subscriber station through the initial ranging procedure. The base station generates a basic connection ID (CID) mapped to the MAC address of the subscriber station, and a primary management CID, and transmits the generated basic CID and primary management CID to the subscriber station. The subscriber station recognizes its own basic CID and primary management CID through the initial ranging procedure.

The IEEE 802.16a/IEEE 802.16e communication system, because it utilizes OFDM/OFDMA, needs subchannels and ranging codes for the ranging procedure. A base station allocates available ranging codes according to objects or types of the rangings.

The ranging code is generated by segmenting a pseudo-random noise (PN) sequence having a predetermined length of, for example, (2¹⁵−1) bits on a predetermined unit basis. Generally, two ranging subchannels having a length of 53 bits constitute one ranging channel, and a PN code is segmented through a ranging channel having a length of 106 bits to generate ranging codes. Of the configured ranging codes, a maximum of 48 ranging codes RC#1 to RC#48 can be allocated to the subscriber stations, and as a default value, a minimum of 2 ranging codes per subscriber station are applied to the rangings of the 3 objects, i.e., an initial ranging, a periodic ranging, and a bandwidth request ranging. Accordingly, different ranging codes are separately allocated to the rangings of the 3 objects.

For example, N ranging codes are allocated for the initial ranging (N RCs (Ranging Codes) for initial ranging), M ranging codes are allocated for the periodic ranging (M RCs for maintenance ranging), and L ranging codes are allocated for the bandwidth request ranging (L RCs for BW-request ranging). The allocated ranging codes, as described above, are transmitted to subscriber stations through a UCD message, and the subscriber stations perform a ranging procedure by using ranging codes included in the UCD message according to their objects.

FIG. 5 is a diagram illustrating a structure of a ranging code generator for generating ranging codes in a conventional OFDMA communication system. Referring to FIG. 5, the ranging codes are generated by segmenting a PN sequence having a predetermined length on a predetermined unit basis as described above. The PN sequence generator, or a ranging code generator, of FIG. 5 has a generation polynomial of 1+x¹+x⁴+x⁷+x¹⁵.

Further, the ranging code generator includes a plurality of memories 510 mapped to respective terms of the generation polynomial, and an exclusive OR (XOR) operator 520 for performing an XOR operation on values output from the memories corresponding to respective taps of the generation polynomial.

In the OFDMA communication system, as described above, one ranging channel includes two ranging subchannels, each subchannel including 53 subcarriers, and uses 106-bit ranging codes. Each subscriber station randomly selects any one of the ranging codes, and performs a ranging procedure using the randomly selected ranging code.

The ranging code is modulated for subcarriers in the ranging channel on a bit-by-bit basis using Binary Phase Shift Keying (BPSK), before being transmitted. Therefore, the ranging codes have a characteristic showing no correlation between them. As a result, even though the ranging codes are transmitted at the same time, a receiver can distinguish the ranging codes.

2. Periodic Ranging

The periodic ranging represents ranging that is periodically performed to adjust a channel status with a base station by a subscriber station that adjusted a time offset with the base station and transmission power through the initial ranging. The subscriber station performs the periodic ranging using ranging codes allocated for the periodic ranging.

3. Bandwidth Request Ranging

The bandwidth request ranging is ranging used to request bandwidth allocation for actually perform communication with a base station by a subscriber station that adjusted a time offset with the base station and transmission power through the initial ranging.

Referring to FIG. 4, an uplink frame 400 includes an initial ranging contention slot field 410 allocated for initial ranging and periodic ranging, a bandwidth request contention slot field 420 allocated for bandwidth request ranging, and a plurality of uplink burst fields 430 to 440 including uplink data of subscriber stations. The initial ranging contention slot field 410 has a plurality of access burst periods, each including actual initial ranging and periodic ranging, and a collision period in case a collision occurs between a plurality of access burst periods. The bandwidth request contention field 420 includes a plurality of bandwidth request periods, including an actual bandwidth request ranging, and a contention period in case a collision occurs between a plurality of bandwidth request rangings. Each of the uplink burst fields 430 to 440 includes a plurality of burst regions (an SS#1 scheduled data region to an SS#n scheduled data region), such that the uplink data can be separately transmitted by the subscriber stations. Each of the burst regions includes a preamble 431 and an uplink burst 433.

FIG. 6 is a diagram schematically illustrating a communication procedure using the messages described in connection with FIGS. 3 and 4 in a BWA communication system. Referring to FIG. 6, upon a power-on, a subscriber station (SS) 620 monitors all frequency bands previously set in the subscriber station 620, and detects a pilot channel signal having a highest power, e.g., a highest carrier to interference and noise ratio (CINR). The subscriber station 620 determines a base station 600 that transmitted a pilot channel signal having the highest CINR as its base station to which it currently belongs, and acquires system synchronization with the base station 600 by receiving a preamble of a downlink frame transmitted from the base station 600.

If system synchronization between the subscriber station 620 and the base station 600 is acquired as described above, the base station 600 transmits a DL-MAP message and a UL-MAP message to the subscriber station 620 in Steps 601 and 603. The DL-MAP message, as described in connection with Table 1, provides the subscriber station 620 with information for synchronizing the base station 600 and the subscriber station in a downlink, and informing on a configuration of a physical channel capable of receiving messages transmitted to respective subscriber stations in the downlink based on the necessary information. The UL-MAP message, as described in conjunction with Table 2, provides the subscriber station 620 with information on a scheduling period of the subscriber station and a configuration of a physical channel in an uplink.

The DL-MAP message is periodically transmitted from the base station 600 to all subscriber stations, and if the subscriber station 620 can continuously receive the DL-MAP message, then the subscriber station 620 synchronizes with the base station 600. That is, subscriber stations receiving the DL-MAP message can receive all messages transmitted over a downlink.

As described with reference to Table 3, when the subscriber station 620 fails in access, the base station 600 transmits the UCD message, which includes information of an available backoff value, to the subscriber station 620.

To perform the ranging, the subscriber station 620 sends a ranging request (RNG-REQ) message to the base station 600 in Step 605, and the base station 600 receiving the RNG-REQ message sends a ranging response (RNG-RSP) message including information for correcting the above-stated frequency, time, and transmission power, to the subscriber station 620 in Step 607.

A configuration of the RNG-REQ message is shown below in Table 4 below.

TABLE 4

| Syntax | Size | Notes |
|---|---|---|
| RNG-REQ_Message_Format( ) { | | |
| Management Message Type = 4 | 8 bits | |
| Downlink Channel ID | 8 bits | |
| Pending Until Complete | 8 bits | |
| TLV Encoded Information | Variable | TLV specific |
| } | | |

As shown in Table 4, ‘Downlink Channel ID’ represents a downlink channel identifier (ID) included in the RNG-REQ message that is received by the subscriber station 620 through the UCD. ‘Pending Until Complete’ represents a priority of a ranging response being transmitted. For example, ‘Pending Until Complete’=0 indicates that a previous ranging response has higher priority, and ‘Pending Until Complete’≠0 indicates that a current ranging response has higher priority.

In addition, a configuration of the RNG-RSP message responsive to the RNG-REQ message is shown below in Table 5.

TABLE 5

| Syntax | Size | Notes |
|---|---|---|
| RNG-RSP_Message_Format( ) { | | |
| Management Message Type = 5 | 8 bits | |
| Uplink Channel ID | 8 bits | |
| TLV Encoded Information | Variable | TLV specific |
| } | | |

As shown in Table 5, an ‘Uplink channel ID’ is an uplink channel ID included in the RNG-REQ message.

In the IEEE 802.16a OFDMA communication system, the RNG-REQ can also be replaced by providing a dedicated ranging period, such that the rangings can be efficiently performed, and transmitting a ranging code.

FIG. 7 is a diagram schematically illustrating a communication procedure in an OFDM/OFDMA BWA communication system. Referring to FIG. 7, a base station 700 transmits a DL-MAP message and a UL-MAP message to a subscriber station 720 in Steps 701 and 703, as described in connection with FIG. 6. In the OFDMA communication system, in Step 705, the subscriber station 720 transmits a Ranging Code, instead of the RNG-REQ message used in FIG. 6, and the base station 700 receiving the Ranging Code transmits an RNG-RSP message to the subscriber station 720 in Step 707.

New information must be added such that information on the Ranging Code transmitted to the base station 700 can be recorded in the RNG-RSP message. The new information that must be added to the RNG-RSP message includes:
1. Ranging Code: a received ranging CDMA code
2. Ranging Symbol: an OFDMA symbol in the received ranging CDMA code
3. Ranging Subchannel: a ranging subchannel in the received ranging CDMA code
4. Ranging Frame Number: a frame number in the received ranging CDMA code

In the IEEE 802.16a OFDMA communication system, 48 ranging codes, each having a length of 106 bits, are divided into three groups, and the three groups are separately used for initial ranging, periodic ranging, and bandwidth request ranging. A time period for which one ranging code is transmitted is called a “ranging slot.” In an initial ranging process, one ranging slot includes two symbols, and in periodic ranging and bandwidth request ranging processes, one ranging slot includes one symbol.

Initial Ranging Procedure

FIG. 8 is a flow diagram illustrating an initial ranging procedure in an OFDM/OFDMA BWA communication system. Referring to FIG. 8, upon powering-on, a subscriber station 820 monitors all frequency bands previously set in the subscriber station 820, and detects a pilot channel signal having a highest power, e.g., a highest carrier to interference and noise ratio (CINR). The subscriber station 820 determines a base station 800 that transmitted a pilot channel signal having the highest CINR as its base station to which it currently belongs, and acquires system synchronization with the base station 800 by receiving a preamble of a downlink frame transmitted from the base station 800.

If system synchronization between the subscriber station 820 and the base station 800 is acquired as described above, the base station 800 transmits a DL-MAP message to the subscriber station 820 (not shown). The DL-MAP message includes a ‘PHY Synchronization’ being set according to a modulation scheme and a demodulation scheme used for a physical (PHY) channel for acquiring synchronization, a ‘DCD Count’ representing a count corresponding to a change in configuration of a DCD message including a downlink burst profile, a ‘Base Station ID’ representing a Base Station Identifier (BSID), a ‘Number of DL-MAP Elements n’ representing the number of elements following the Base Station ID, and information on ranging codes allocated separately to the rangings.

After transmitting the DL-MAP message, the base station 800 transmits a UCD message to the subscriber station 820 (not shown). The UCD message includes an ‘Uplink Channel ID’ representing an uplink channel ID in use, a ‘Configuration Change Count’ counted in a base station, a ‘Mini-slot Size’ representing a size of mini-slots in an uplink physical channel, a ‘Ranging Backoff Start’ representing a start point of a backoff for initial ranging, i.e., representing a size of an initial backoff window for initial ranging, a ‘Ranging Backoff End’ representing an end point of a backoff for initial ranging, i.e., representing a size of a final backoff window, a ‘Request Backoff Start’ representing a start point of a backoff for contention data and requests, i.e., representing a size of an initial backoff window, and a ‘Request Backoff End’ representing an end point of a backoff for contention data and requests, i.e., representing a size of a final backoff window. The ‘Request Backoff Start’ corresponds to MIN_WIN representing a minimum window size for an exponential random backoff algorithm described herein below. The ‘Request Backoff End’ corresponds to MAX_WIN representing a maximum window size for the exponential random backoff algorithm. The exponential random backoff algorithm will be described in more detail below.

The backoff value represents a kind of a waiting time for which a subscriber station should wait for a next ranging when it failed in a previous ranging. When the subscriber station fails in ranging, the base station must transmit the backoff value to the subscriber station, which is information on a time for which it must wait for a next ranging. If it is assumed that a backoff value for a case in which the subscriber station fails in ranging is k, the subscriber station transmits a next ranging code after waiting for a ranging slot by a value randomly selected from [1,2^{k}]. The backoff value k is increased up to the Ranging Backoff End value from the Ranging Backoff Start value one by one each time a ranging attempt is made.

After transmitting the UCD message, the base station 800 transmits a UL-MAP message to the subscriber station 820 in Step 801. Upon receiving the UL-MAP message from the base station 800, the subscriber station 820 can recognize ranging codes used for the initial ranging, information on a modulation scheme and a demodulation scheme, a ranging channel, and a ranging slot. The subscriber station 820 randomly selects one ranging code from the ranging codes used for the initial ranging, randomly selects one ranging slot from the ranging slots used for the initial ranging, and transmits the selected ranging code to the base station 800 through the selected ranging slot in Step 803. Transmission power used for transmitting the ranging code in step 803 has a minimum transmission power level.

If the subscriber station 820 fails to receive a separate response from the base station 800, even though it transmitted the ranging code, the subscriber station 820 again randomly selects one ranging code from the ranging codes used for the initial ranging, randomly selects one ranging slot from the ranging slots used for the initial ranging, and transmits the selected ranging code to the base station 800 through the selected ranging slot in Step 805. Transmission power used for transmitting the ranging code in step 805 is higher in power level than the transmission power used for transmitting the ranging code in step 803. Of course, if the subscriber station 820 receives a response to the ranging code transmitted in step 803 from the base station 800, step 805 can be skipped.

Upon receiving a random ranging code through a random ranging slot from the subscriber station 820, the base station 800 transmits to the subscriber station 820 a ranging response (RNG-RSP) message including information indicating a successful receipt of the ranging code, for example, an OFDMA symbol number, a subchannel, and a ranging code in Step 807.

Although not illustrated in FIG. 8, upon receiving the RNG-RSP message, the subscriber station 820 adjusts time and frequency offsets and transmission power using the information included in the RNG-RSP message. In addition, the base station 800 transmits a UL-MAP message including CDMA Allocation IE for the subscriber station 820 to the subscriber station 820 in Step 809. The CDMA Allocation IE includes information on an uplink bandwidth at which the subscriber station 820 will transmit a ranging request (RNG-REQ) message.

The subscriber station 820 that is receiving the UL-MAP message from the base station 800 detects CDMA Allocation IE included in the UL-MAP message, and transmits an RNG-REQ message including a MAC address to the base station 800 using uplink resource, or the uplink bandwidth, included in the CDMA Allocation IE in Step 811. The base station 800 that is receiving the RNG-REQ message from the subscriber station 820 transmits an RNG-RSP message including connection IDs (CIDs), i.e., a basic CID and a primary management CID, to the subscriber station 820 according to a MAC address of the subscriber station 820 in Step 813.

After performing the initial ranging procedure as described above in conjunction with FIG. 8, the subscriber station recognizes a basic CID and a primary management CID uniquely allocated thereto. Further, in the initial ranging procedure, because the subscriber station randomly selects a ranging slot and a ranging code and transmits the randomly selected ranging code for the randomly selected ranging slot, the same ranging codes transmitted by different subscriber stations may collide with each other at one ranging slot. When ranging codes collide with each other in this way, the base station cannot identify the collided ranging codes, and thus cannot transmit the RNG-RSP message. In addition, because the RNG-RSP message cannot be received from the base station, the subscriber station repeats transmission of a ranging code for the initial ranging, after waiting for a backoff value corresponding to the exponential random backoff algorithm.

If a minimum window size and a maximum window size used in the exponential random backoff algorithm are defined as MIM_WIN and MAX_WIN, respectively, the subscriber station randomly selects one ranging slot among 2^{MIN}^{_{—}}^{WIN} ranging slots during first ranging code transmission, and transmits a ranging code for the selected ranging slot. If ranging code collision occurs during the first ranging code transmission, the subscriber station randomly selects one ranging slot again among following (2^{MIN}^{_{—}}^{WIN+1}) ranging slots from the corresponding ranging slot during second ranging code transmission, and transmits a ranging code for the selected ranging slot. If ranging code collision occurs during the second ranging code transmission, the subscriber station randomly selects one ranging slot again among following (2^{MIN}^{_{—}}^{WIN+2}) ranging slots from the corresponding ranging slot during third ranging code transmission, and transmits a ranging code for the selected ranging slot. Accordingly, when a subscriber station randomly selects one ranging slot from 2^{k} ranging slots, ‘k’ is defined as a window size. The window size k used during the ranging code retransmission process is increased one by one from MIN_WIN until the ranging code transmission is successful, i.e., until an RNG-RSP message is received, and window size k is increased until it reaches the maximum window size MAX_WIN.

Periodic Ranging Procedure

FIG. 9 is a flow diagram illustrating a periodic ranging procedure in an OFDM/OFDMA BWA communication system. Referring to FIG. 9, a subscriber station 920 receives an Uplink Channel Descript (UCD) message from a base station 900, and detects a ranging code used for periodic ranging and modulation/demodulation information from the received UCD message. Further, the subscriber station 920 receives a UL-MAP message from the base station 900 in Step 901, and detects a ranging channel and a ranging slot used for periodic ranging from the UL-MAP message.

Thereafter, the subscriber station 920 selects a random ranging code from a periodic ranging code set and transmits the selected ranging code for a particular one ranging slot in Step 903. If the base station 900 identifies the ranging code transmitted by the subscriber station 920, the base station 900 broadcasts the received ranging code and its corresponding ranging slot, and timing/frequency/power adjustment parameters through an RNG-RSP message in Step 905.

The subscriber station 920 adjusts timing/frequency/power offset through the RNG-RSP message corresponding to the ranging code and ranging slot transmitted by the subscriber station 920. Although one ranging slot includes two symbols in the initial ranging procedure, one ranging slot includes one symbol in the periodic ranging procedure. In addition, because a basic CID and a primary management CID are allocated in the initial ranging procedure, a process of allocating CIDs is omitted in the periodic ranging procedure.

If a status value of the RNG-RSP message transmitted by the base station 900 indicates ‘Continue’, the subscriber station 920 stores the status value as Continue. In this case, the base station 900 repeats the periodic ranging procedure for the subscriber station 920 during transmission of a next UL-MAP message. Therefore, the base station 900 transmits a UL-MAP message to the subscriber station 920 in Step 907, and the subscriber station 920 detects a ranging channel and a ranging slot used for periodic ranging from the UL-MAP message.

As described above, the subscriber station 920 selects a random ranging code from a periodic ranging code set and transmits the selected ranging code for a random ranging slot in Step 909. If the base station 900 identifies the ranging code transmitted by the subscriber station 920, the base station 900 broadcasts the received ranging code and its corresponding ranging slot, and timing/frequency/power adjustment parameters through an RNG-RSP message in Step 911. Thereafter, the subscriber station 920 adjusts timing/frequency/power offset through the RNG-RSP message corresponding to the ranging code and ranging slot transmitted by the subscriber station 920.

If a status value of the RNG-RSP message transmitted by the base station 900 represents ‘Success’, the subscriber station 920 stores the status value as Success. In this case, the base station 900 ends the periodic ranging procedure for the subscriber station 920. In the periodic ranging procedure, because the subscriber station 920 repeatedly performs data transmission, the base station 900 and the subscriber station 920 repeat the periodic ranging procedure every predetermined time period.

Bandwidth Request Ranging Procedure

The bandwidth request ranging is ranging used to request bandwidth allocation to actually perform communication with a base station by a subscriber station that has adjusted a time offset with the base station and transmission power through the initial ranging.

FIG. 10 is a flow diagram illustrating a bandwidth request ranging procedure in an OFDM/OFDMA BWA communication system. Referring to FIG. 10, a subscriber station 1020 randomly selects a ranging code from a group of the ranging codes used for the bandwidth request ranging, randomly selects one ranging slot among ranging slots used for the bandwidth request ranging, and transmits the selected ranging code to a base station 1000 through the selected ranging slot in Step 1001. If the subscriber station 1020 fails to receive a separate response from the base station 1000 even though it transmitted the ranging code, the subscriber station 1020 once again randomly selects one ranging code from the ranging codes used for the initial ranging, randomly selects one ranging slot from the ranging slots used for the bandwidth request ranging, and transmits the selected ranging code to the base station 1000 through the selected ranging slot in Steps 1003 and 1005. Of course, if the subscriber station 1020 receives a response to the ranging code transmitted in step 1001 from the base station 1000, steps 1013 and 1015 are skipped.

Upon receiving a random ranging code through a random ranging slot from the subscriber station 1020, the base station 1000 transmits a UL-MAP message including CDMA Allocation IE to the subscriber station 1020 in Step 1007. The CDMA Allocation IE includes information on an uplink bandwidth at which the subscriber station 1020 will transmit a bandwidth request (BW-REQ) message. The subscriber station 1020 receiving the UL-MAP message from the base station 1000 detects CDMA Allocation IE included in the UL-MAP message, and transmits a BW-REQ message to the base station 1000 using uplink resource, or the uplink bandwidth, included in the CDMA Allocation IE in Step 1009.

The base station 1000 receiving the BW-REQ message from the subscriber station 1020 allocates an uplink bandwidth for data transmission by the subscriber station 1020. Further, the base station 1000 transmits to the subscriber station 1020 a UL-MAP message including information on an uplink bandwidth allocated for data transmission by the subscriber station 1020 in Step 1011. The subscriber station 1020 receiving the UL-MAP message from the base station 1000 recognizes the uplink bandwidth allocated for data transmission, and transits data to the base station 1000 through the uplink bandwidth in Step 1013.

After performing the bandwidth request ranging procedure as described in conjunction with FIG. 10 above, the subscriber station can transmit data to the base station. In the bandwidth request ranging procedure, as described in the initial ranging procedure, because the subscriber station randomly selects a ranging slot and a ranging code and transmits the randomly selected ranging code for the randomly selected ranging slot, the same ranging codes transmitted by different subscriber stations may collide with each other at one ranging slot. When ranging codes collide with each other, the base station cannot identify the collided ranging codes, and thus cannot allocate an uplink bandwidth. In addition, because the subscriber station cannot be allocated an uplink bandwidth from the base station, the subscriber station repeats transmission of a ranging code for the bandwidth request ranging after waiting for a backoff value corresponding to the exponential random backoff algorithm.

FIG. 11 is a diagram schematically illustrating a backoff procedure during initial ranging, periodic ranging, and bandwidth request ranging in a conventional OFDMA communication system. However, before a description of FIG. 11 is given, it should be noted that although the backoff procedure of FIG. 11 can be applied to all of the initial ranging procedure, the periodic ranging procedure, and the bandwidth request ranging procedure, the backoff procedure will be applied herein only to the initial ranging procedure for the convenience of explanation.

Referring to FIG. 11, one frame includes L ranging slots for initial ranging. Three subscriber stations transmit ranging codes at a 3^{rd} ranging slot among the L ranging slots, and the three subscriber stations transmit ranging codes at an L^{th} ranging slot. Here, the three subscriber stations transmitting ranging codes at the 3^{rd} ranging slot will be referred to as a first subscriber station 1101, a second subscriber station 1103, and a third subscriber station 1105, respectively. Further, the three subscriber stations transmitting ranging codes at the L^{th} ranging slot will be referred to as a fourth subscriber station 1107, a fifth subscriber station 1109, and a sixth subscriber station 1111, respectively.

At the 3^{rd} ranging slot, the first subscriber station 1101 transmits a ranging code #1, and the second and third subscriber stations 1103 and 1105 transmit ranging codes #2. Accordingly, when ranging codes are transmitted using the same ranging codes, i.e., the ranging codes #2, at the same ranging slot, the ranging codes #2 collide with each other, such that the base station cannot recognize the ranging codes #2 (See 1120).

As described above, data transmitted by a plurality of subscriber stations at the same slot (or same time) can be distinguished by the ranging codes (for example, PN codes). However, if different subscriber stations transmit data using the same code at the same time, the base station cannot distinguish the data transmitted individually by the subscriber stations.

Therefore, the second subscriber station 1103 and the third subscriber station 1105 cannot receive separate responses from the base station, and perform backoff according to the exponential random backoff algorithm. That is, the second subscriber station 1103 transmits a ranging code using a ranging code #3 at a 4^{th} ranging slot of a second frame (1115), and the third subscriber station 1105 transmits a ranging code using the ranging code #2 again at a 2^{nd} ranging slot of the second frame (1113).

At the L^{th} ranging slot, the fourth subscriber station 1107 and the fifth subscriber station 1109 transmits ranging codes #1, and the sixth subscriber station 1111 transmits a ranging code #3. Accordingly, when ranging codes are transmitted using the same ranging codes, i.e., the ranging codes #1, at the same ranging slot, the ranging codes #1 collide with each other, such that the base station cannot recognize the ranging codes #1 (1130). Therefore, the fourth subscriber station 1107 and the fifth subscriber station 1109 cannot receive separate responses from the base station, and perform backoff according to the exponential random backoff algorithm. Although backoffs for the fourth subscriber station 1107 and the fifth subscriber station 1109 are not separately illustrated in FIG. 11, they are identical in operation to the backoffs for the second subscriber station 1103 and the third subscriber station 1105.

As described above, in the OFDMA communication system, a subscriber station randomly selects ranging slots and ranging codes for initial ranging, periodic ranging, and bandwidth request ranging during the initial ranging, periodic ranging, and bandwidth request ranging, thereby causing frequent ranging code collisions. The ranging code collisions prevent the base station from recognizing a ranging code for the subscriber station, and the base station cannot perform an operation any longer. Although the subscriber station performs backoff according to the exponential random backoff algorithm due to the ranging code collision, transmission of a ranging code by the backoff may also cause collisions, leading to an access delay to the base station by the subscriber station. The access delay causes performance degradation of the OFDMA communication system.

In the periodic ranging procedure, a time from first ranging code transmission by the subscriber station to first RNG-RSP message transmission by the subscriber station can be defined as an “access delay time.” In the bandwidth request ranging procedure, a time required from first ranging code transmission to a time when information indicating successful ranging is detected from CDMA Allocation IE in a UL-MAP message received can be defined as an “access delay time.”

In the IEEE 802.16a OFDMA communication system, because the periodic ranging and the bandwidth request ranging utilize Random Access technology for transmitting a random ranging code at a random ranging slot, occurrence of ranging code collision increases an access delay time through a reconnection procedure after exponential random backoff. Therefore, the maximum access delay time cannot be guaranteed. More specifically, as a code collision rate is higher, an access delay time becomes longer, resulting in performance degradation of the system.

As described above, because it is necessary to consider mobility of a subscriber station and a multicell configuration in the OFDM/OFDMA BWA communication system, there is a possible situation in which a plurality of subscriber stations perform the rangings.

FIG. 12 is a diagram illustrating a method for transmitting ranging signals in a multicell configuration in an OFDM/OFDMA BWA communication system. Referring to FIG. 12, the OFDM/OFDMA communication system includes a plurality of cells. For simplicity, it is assumed in FIG. 12 that the OFDM/OFDMA communication system includes three cells (cell A (1200), a cell B (1210), and a cell C (1220)). A base station A (1201) OFDM/OFDMA communicates with a plurality of subscriber stations 1203 and 1205 located in the cell A 1200, a base station B (1211) OFDM/OFDMA communicates with a plurality of subscriber stations 1213 and 1215 located in the cell B 1210, and a base station C (1221) OFDM/OFDMA communicates with a plurality of subscriber stations 1223, 1225 and 1227 located in the cell C 1220.

As described above, the subscriber stations perform initial ranging, periodic ranging, and bandwidth request ranging at ranging slots in a predetermined frame in order to perform ranging with their corresponding base stations. For the rangings, the subscriber stations use ranging codes, and the ranging codes are transmitted by performing inverse fast Fourier transform (IFFT) on pseudo noise (PN) codes having a length of N chips. Each PN chip is modulated by a particular subscarrier. The subscriber station randomly selects a particular code in a predetermined PN code group according to use of the ranging signal, and then generates and transmits a signal.

For example, in FIG. 12, the subscriber station 1203, which is located in the cell A 1200, can transmit a ranging code with PN #1 (or PN code #1), and the subscriber station 1205, in the cell A 1200, can transmit a ranging code with PN #2. In addition, the subscriber station 1213, which is located in the cell B 1210, can transmit a ranging code with PN #4, and the subscriber station 1215, also in the cell B 1210, can transmit a ranging code with the PN #4. If the subscriber station 1213 and the subscriber station 1215 transmit the ranging codes at the same time, collision occurs because the two ranging codes use the same PN codes. Conventionally, the two collided ranging codes are retransmitted by performing exponential random backoff.

Similarly, because the subscriber stations 1223, 1225, and 1227 located in the cell C 1220 perform rangings by randomly selected PN codes, they may select different codes in some cases and may select same codes in other cases. If a plurality of subscriber stations use the same ranging codes at the same slot as described in the cell B 1210, collision happens.

If the subscriber station 1205 that is attempting ranging with the base station A 1201 of cell A 1200 transmits a ranging code that uses PN #5 and the subscriber station 1223 that is attempting ranging with the base station C 1221 of cell C 1220 at the same time transmits a ranging code that uses the PN #5, mutual interference occurs between them. That is, if subscriber stations transmit ranging signals using the same PN codes between neighbor cells, signal interference occurs between the neighbor cells.

In order to remove the inter-cell signal interference, a unique PN code must be allocated to each subscriber station. In this case, however, a physical structure of a receiver becomes complicated.

FIG. 13 is a block diagram illustrating a base station apparatus for detecting ranging signals in an OFDM/OFDMA BWA communication system. Referring to FIG. 13, the base station includes an N-point fast Fourier transform (FFT) block 1311, a multiplexer (MUX) 1313, a plurality of PN correlators 1315 to 1319, and a time offset/signal power tracker 1321. The N-point FFT block 1311 receives ranging signals from a plurality of subscriber stations, converts the ranging signals into L PN codes in a frequency domain, and outputs the PN codes to the multiplexer 1313. The multiplexer 1313 multiplexes the PN codes, and outputs the multiplexed PN codes to the PN correlators 1315 to 1319. The PN correlators 1315 to 1319 should be identical in number to the ranging codes, such as to separately detect the ranging codes. For example, in order to detect K ranging codes as illustrated in FIG. 13, K PN correlators are needed. From the ranging codes detected by the PN correlators 1315 to 1319, the time offset/signal power tracker 1321 tracks time offset and signal power.

When a PN code used by a particular base station is different from a PN code used by a neighbor base station as illustrated in FIG. 13, the total number of ranging codes required in the entire system becomes very large, and it becomes difficult to manage the many codes in a network. In addition, during a handover, because each base station must have the capability to detect ranging codes allocated to neighbor base stations, a base station ranging implementation algorithm becomes very complicated. As described above in conjunction with FIG. 13, K PN code correlators and their associated time offset tracking algorithms are required.

When a plurality of subscriber stations attempt ranging to a base station according to the conventional IEEE 802.16a technology, a number of problems occur.

First, although the current IEEE 802.16 technology provides that respective cells commonly use a PN code set according to use of rangings, when subscriber stations located in neighbor cells transmit ranging signals using the same PN codes as illustrated in FIG. 12, signal interference occurs between the neighbor cells. For example, if a subscriber station X in a base station X and a subscriber station Y in a base station Y use the same ranging codes at the same transmission time and the same transmission frequency, the respective base stations receive the same two ranging codes, which they cannot distinguish. Because the two codes cannot be distinguished, during ranging time error estimation, the base station does not recognize the received ranging code as a signal transmitted by the two different subscriber stations, but recognizes a signal transmitted by one subscriber station as a signal received via two channel paths.

Accordingly, in the current technology, it is not possible to use a common subcarrier (frequency reuse) for generation of ranging signals in order to remove the signal interference.

As described in connection with FIG. 13, if it is presumed that all subscriber stations located in each cell use their own unique PN codes, the signal interference between neighbor cells can be avoided. In this case, however, the total number of necessary PN codes increases in proportion to the product of the total number of base stations and the total number of subscriber stations. In addition, it is not easy to manage the many codes in an upper network (e.g., base station manager or exchange). Further, during a handover, each base station must undesirably have a capability of searching ranging signals for PN codes allocated to subscriber stations belonging to a minimum number of neighbor base stations. Moreover, when a new cell is added to an old cell, even the neighbor cell has the same problem.

Second, when each subscriber station randomly selects a periodic ranging code for time offset tracking and channel condition compensation after initial base station access as specified in the current IEEE 802.16a technology, the base station can recognize the received periodic ranging code, but cannot map the detected periodic ranging code with a subscriber station that transmitted the ranging code. Therefore, the base station cannot identify which subscriber station has used the periodic ranging code. When the base station fails in the subscriber station identification, it is impossible for the base station to transmit a ranging response (RNG-RSP) including synchronization correction, signal power, and ranging status only to a corresponding subscriber station. Therefore, undesirably, the base station transmits the ranging response to all subscriber stations over a broadcasting channel.

Third, in a wireless environment to which additive white Gaussian noises (AWGN) are added, reception performance is deteriorated due to a lack of orthogonality between the PN codes. In case of the PN codes, a correlation characteristic between codes does not guarantee orthogonality. Therefore, when the PN codes share a transmission time slot and a transmission frequency, inter-code interference occurs due to a lack of orthogonality between ranging codes, thereby deteriorating ranging performance.

Fourth, according to the current IEEE 802.16 technology, when a periodic ranging time slot for a subscriber station is not allocated, a base station may receive many ranging signals at the same time. In this case, because the ranging signals share a transmission slot and a transmission frequency, inter-code interference occurs. More specifically, when wireless access channels correspond to multipath channels, frequency selectivity is provided when a channel response is changed according to frequency, thereby causing an increase in inter-code interference. The increased inter-code interference causes ranging failures of all subscriber stations that have attempted rangings.

### SUMMARY OF THE INVENTION

It is, therefore, an object of the present invention to provide a ranging signal modulation apparatus and method for preventing signal interference in a same cell or between neighbor cells in an OFDMA BWA mobile communication system.

It is another object of the present invention to provide a method for easily searching ranging codes allocated to subscriber stations belonging to each base station in an OFDMA BWA mobile communication system.

It is further another object of the present invention to provide a method for easily recognizing a ranging signal for each subscriber station by a base station in an OFDMA BWA mobile communication system.

It is yet another object of the present invention to provide a method for reducing a time required for initial access, handover, and bandwidth request ranging in an OFDMA BWA mobile communication system.

It is still another object of the present invention to provide a method for transmitting ranging codes without a time delay due to a backoff in an OFDMA BWA mobile communication system.

It is still another object of the present invention to provide a method for efficiently transmitting ranging codes by scheduling transmission times of the ranging codes according to subscriber stations in an OFDMA BWA mobile communication system.

In accordance with one aspect of the present invention, there is provided a method for transmitting ranging information from at least one base station to subscriber station. The method includes the steps of transmitting first code information for generating a ranging code by the subscriber station, wherein the first code information is different from first code information of a neighboring base station; and transmitting second code information for generating the raging code by the subscriber station, wherein the second code information is different from second code information of a second subscriber station with a cell region of the base station.

In accordance with another aspect of the present invention, there is provided a method for transmitting ranging information from at least one base station to a subscriber stations and generating a ranging code by the subscriber station using received ranging information. The method includes the steps of receiving first code information from the base station, wherein the first code information is different from first code information of a neighboring base station; receiving second code information from the base station, wherein the second code information is different from second code information of a second subscriber station with a cell region of the base station; and generating a new ranging code by combining the first code information with the second code information.

In accordance with further another aspect of the present invention, there is provided an apparatus for transmitting ranging information from at least one base station to subscriber station and generating a ranging code by the subscriber station using received ranging information. The apparatus includes a first code generator for generating a first code using different first code information received from the base stations, wherein the first code information is different from first code information of a neighboring base station; a second code generator for generating a second code using second code information received from the base station, wherein the second code information is different from second code information is different from second code information of a second subscriber station with a cell region of the base station; and a ranging code generator for generating a new ranging code by combining the first code with the second code.

### BRIEF DESCRIPTION OF THE DRAWINGS

The above and other objects, features, and advantages of the present invention will become more apparent from the following detailed description when taken in conjunction with the accompanying drawings in which:

FIG. 1 is a diagram schematically illustrating a configuration of an OFDM/OFDMA Broadband Wireless Access (BWA) communication system;

FIG. 2 is a diagram illustrating a frame configuration of an OFDM/OFDMA BWA communication system in a time-frequency domain;

FIG. 3 is a diagram schematically illustrating a downlink frame configuration for an OFDM/OFDMA BWA communication system;

FIG. 4 is a diagram schematically illustrating a configuration of an uplink frame for an OFDM/OFDMA BWA communication system;

FIG. 5 is a diagram illustrating a structure of a ranging code generator in a general OFDMA/OFDMA BWA communication system;

FIG. 6 a diagram schematically illustrating a communication procedure in an OFDM/OFDMA BWA communication system;

FIG. 7 is a diagram schematically illustrating a communication procedure in an OFDM/OFDMA BWA communication system;

FIG. 8 is a flow diagram illustrating an initial ranging procedure in an OFDM/OFDMA BWA communication system;

FIG. 9 is a flow diagram illustrating a periodic ranging procedure in an OFDM/OFDMA BWA communication system;

FIG. 10 is a flow diagram illustrating a bandwidth request ranging procedure in an OFDM/OFDMA BWA communication system;

FIG. 11 is a diagram schematically illustrating collision occurring during an uplink access in an OFDM/OFDMA BWA communication system;

FIG. 12 is a diagram illustrating a method for transmitting ranging signals in a multicell configuration in an OFDM/OFDMA BWA communication system;

FIG. 13 is a block diagram illustrating a base station apparatus for detecting ranging signals in an OFDM/OFDMA BWA communication system;

FIG. 14 is a diagram illustrating a method for allocating PN codes for ranging in a multicell configuration according to an embodiment of the present invention;

FIG. 15 is a diagram illustrating a method for allocating Walsh codes for ranging to subscriber stations in the same cell according to an embodiment of the present invention;

FIG. 16 is a diagram illustrating a method for allocating new unique ranging codes to respective subscriber stations according to an embodiment of the present invention;

FIG. 17 is a block diagram illustrating a subscriber station transmission apparatus for modulating ranging signals according to an embodiment of the present invention;

FIG. 18 is a block diagram illustrating a base station reception apparatus for detecting ranging signals according to an embodiment of the present invention;

FIG. 19 is a diagram illustrating a detailed structure of a PN correlator according to an embodiment of the present invention;

FIG. 20 is a diagram illustrating a Walsh correlator according to an embodiment of the present invention;

FIG. 21 is a diagram illustrating a method for scheduling transmission of ranging signals of subscriber stations by a base station according to an embodiment of the present invention;

FIG. 22 is a flowchart illustrating a transmission procedure of a base station according to an embodiment of the present invention; and

FIG. 23 is a flowchart illustrating a procedure for generating and transmitting a ranging code by a subscriber station according to an embodiment of the present invention.

### DETAILED DESCRIPTION OF THE PREFERRED EMBODIMENT

Several preferred embodiments of the present invention will now be described in detail herein below with reference to the annexed drawings. In the following description, a detailed description of known functions and configurations incorporated herein has been omitted for conciseness.

The present invention provides a ranging code allocation and transmission method for preventing interference between ranging codes in a multicell configuration, facilitating identification of ranging codes for subscriber stations of each base station, minimizing an access delay time, and preventing ranging code collision in an Orthogonal Frequency Division Multiple Access (OFDMA) communication system.

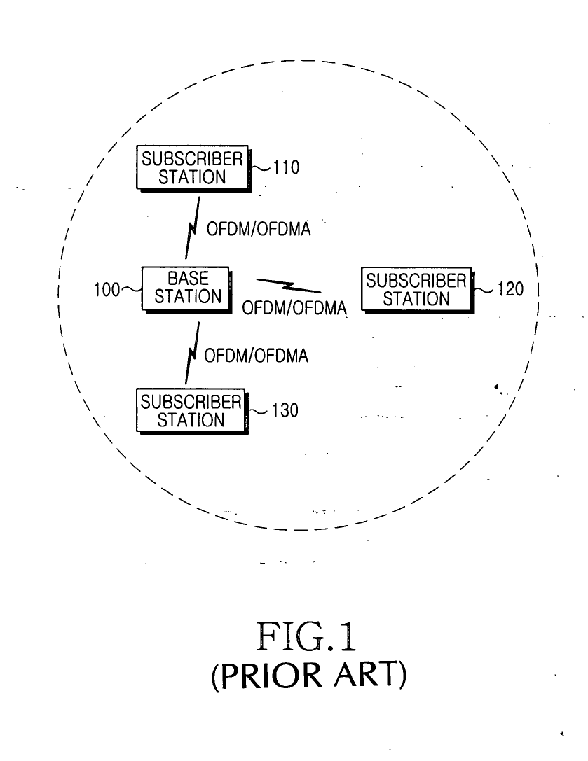

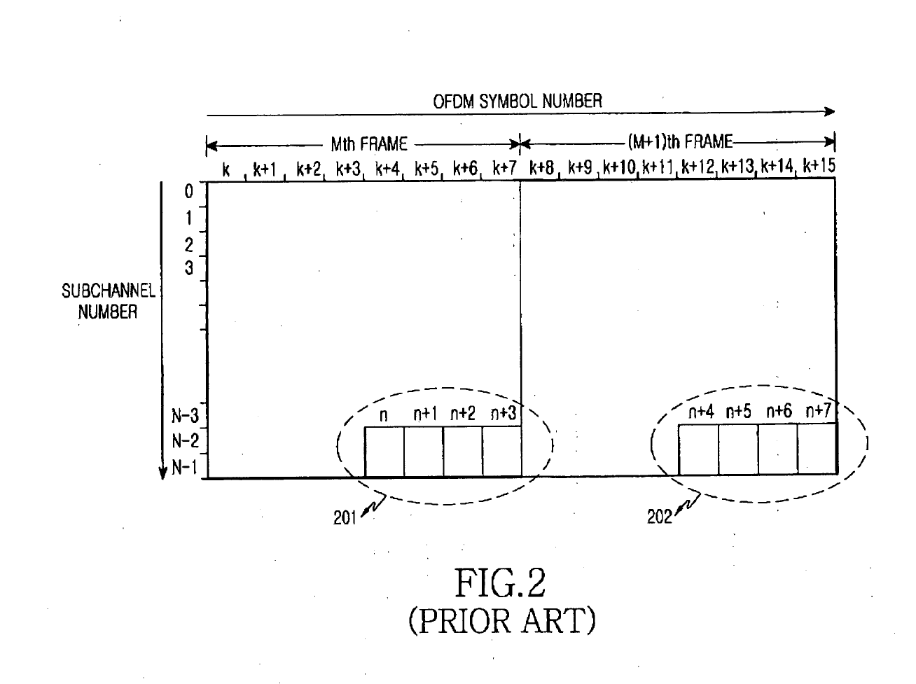

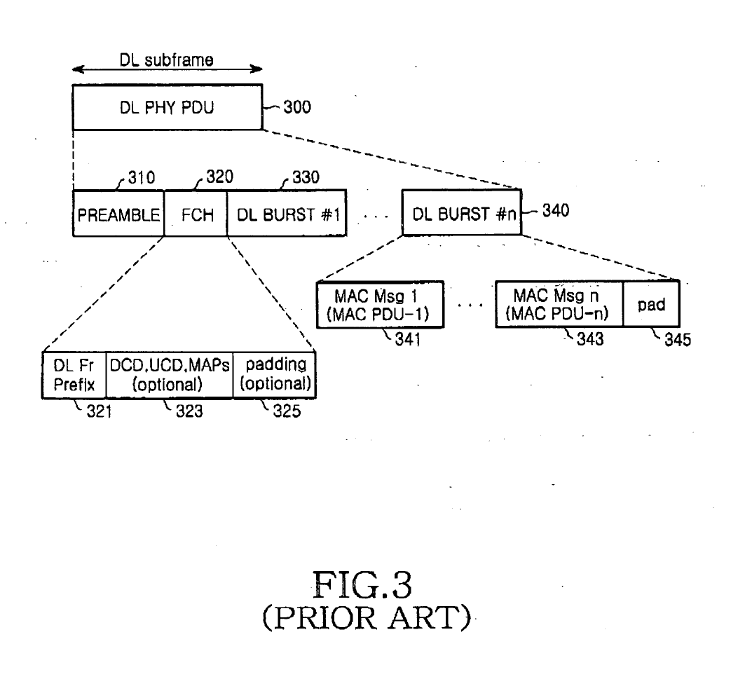

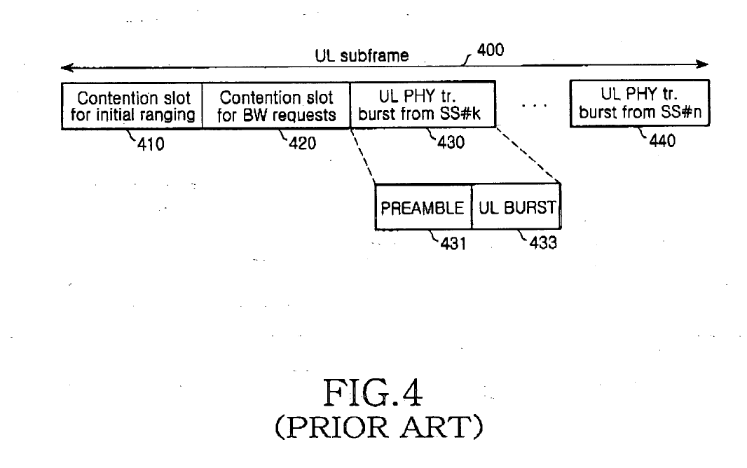

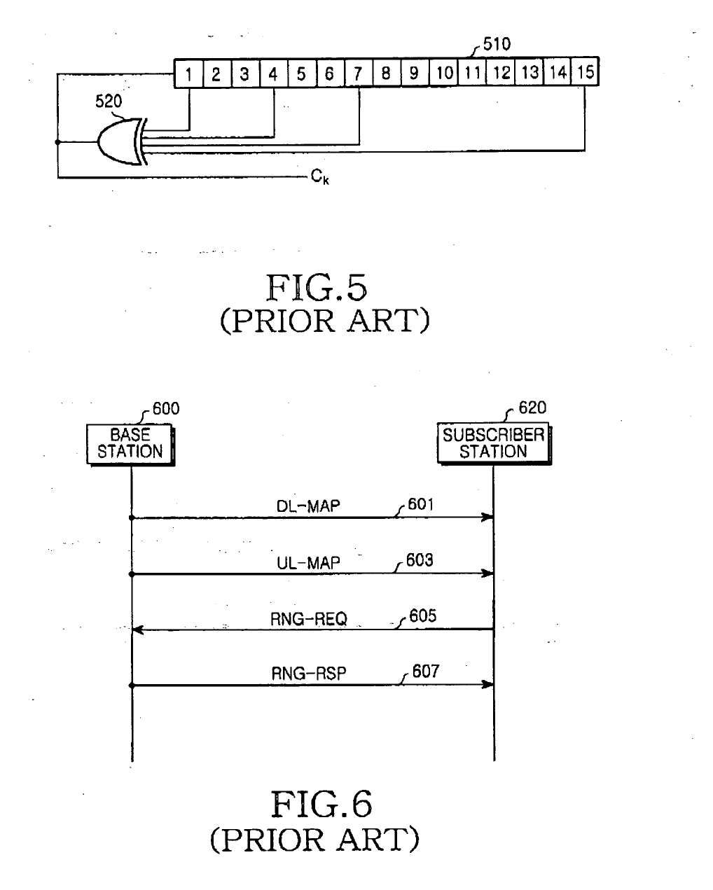

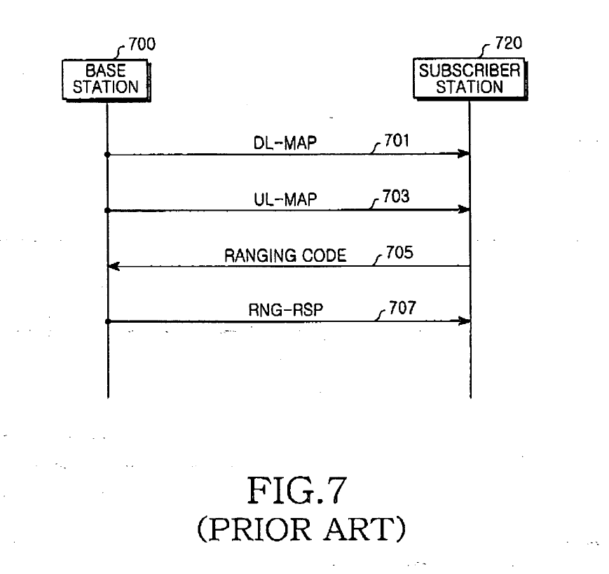

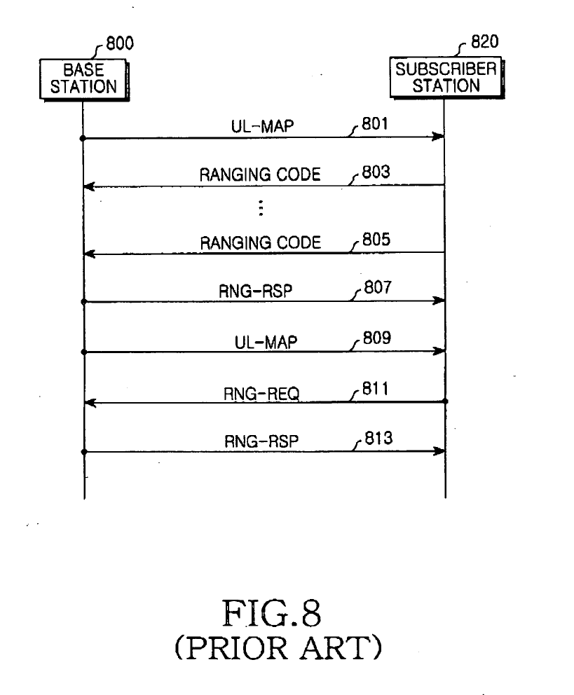

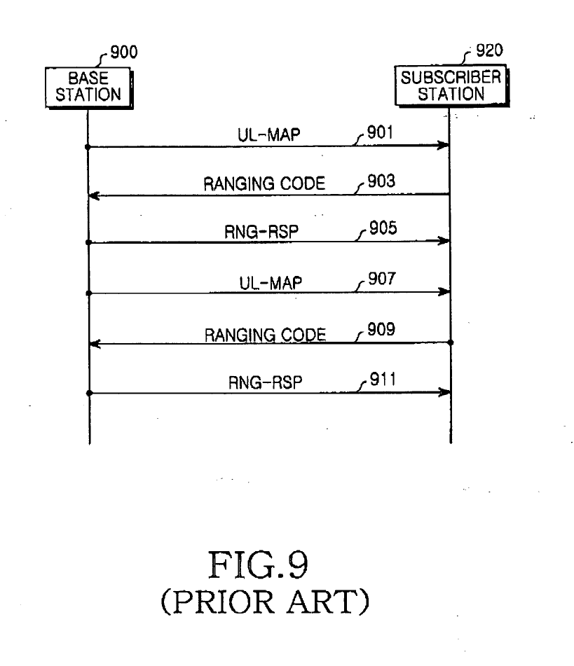

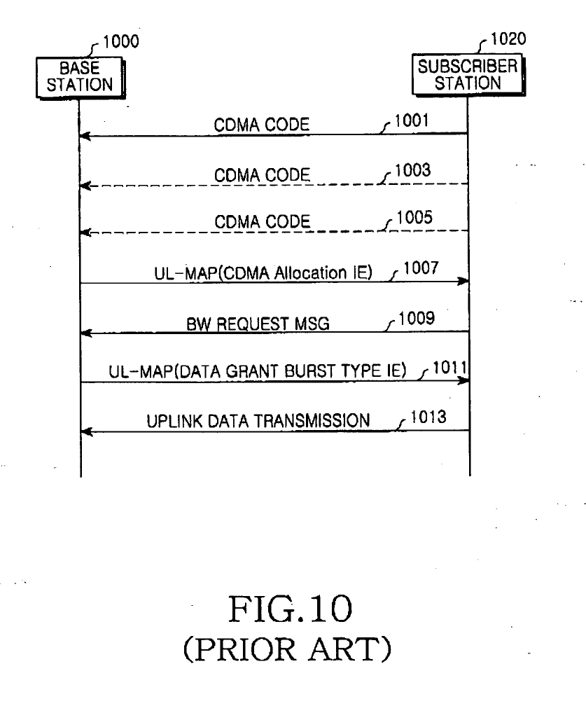

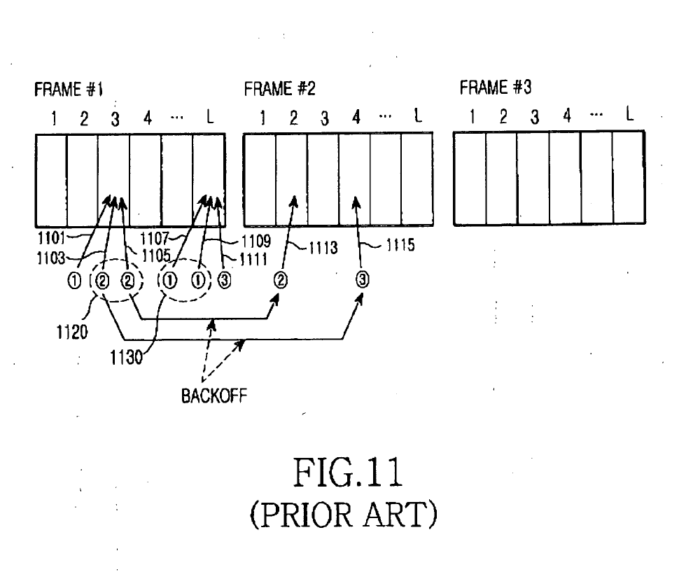

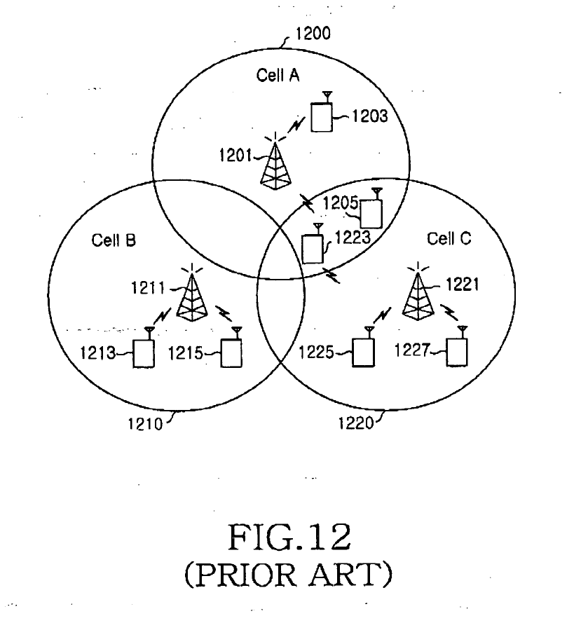

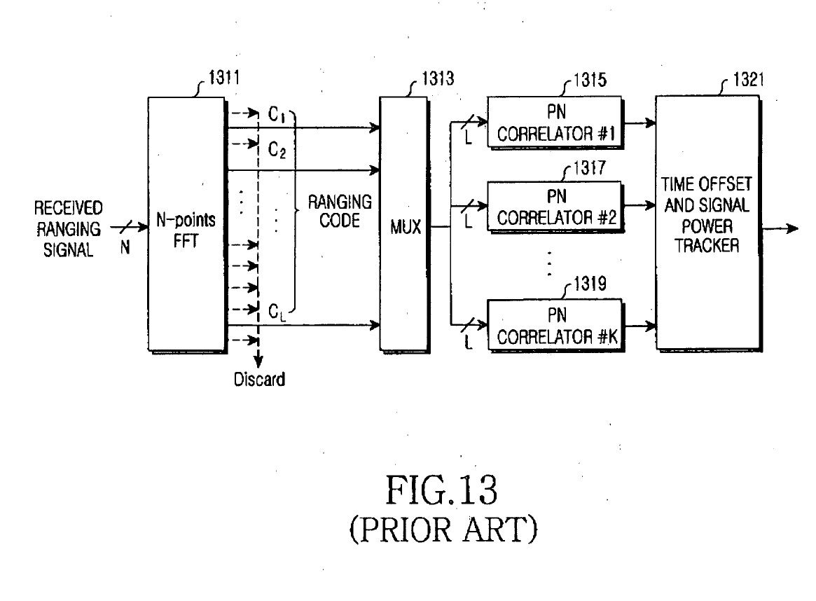

In the following description, it will be assumed that the OFDMA communication system is identical in configuration to the IEEE 802.16a communication system illustrated FIG. 1 described in the Related Art section, and the OFDMA frame is also identical in configuration to the OFDMA frame illustrated in FIG. 2. Also, the present invention can be applied to an IEEE 802.16e communication system, which considers the mobility of a subscriber station in the IEEE 802.16a communication system.

In the present invention, in order to solve the above and other problems, ranging codes are generated using separate codes for respective base stations, and separate codes are allocated to a plurality of subscriber stations in the same cell. In addition, by scheduling unique ranging codes allocated to the subscriber stations such that the ranging codes should be transmitted through a particular slot, the present invention prevents collision between ranging codes, thereby rapidly performing initial ranging, handover, and bandwidth request ranging.

More specifically, in order to prevent collisions between ranging codes for respective subscriber stations, which may occur when uplink ranging codes are randomly transmitted in the ranging procedure, the present invention allocates orthogonal ranging codes to subscriber stations of each base station. Through the ranging code allocation, ranging codes transmitted by subscriber stations attempting an initial radio access to a corresponding base station and subscriber stations attempting periodic ranging after the access are orthogonal with each other. In addition, the ranging codes are also orthogonal with ranging codes transmitted by subscriber stations connected to a plurality of neighbor base stations and subscriber stations attempting an access to the plurality of neighbor base stations.

In order to prevent degradation of ranging detection performance of a corresponding base station caused by the large number of ranging signals received at a particular time slot of the base station, ranging code transmission times are differently set for the respective subscriber stations. In particular, the present invention proposes an efficient uplink access method for periodic ranging in a situation where a plurality of subscriber stations desire to access one base station in a wireless cellular system.

According to an embodiment of the present invention, in generating the ranging codes, PN codes are used as codes for identifying base stations, and Walsh codes are used for identifying subscriber stations belonging to each cell. That is, the subscriber stations are allocated unique ranging codes generated by combining PN codes separately allocated to base stations with Walsh codes separately allocated to subscriber stations, and transmit ranging signals using the allocated unique ranging codes.

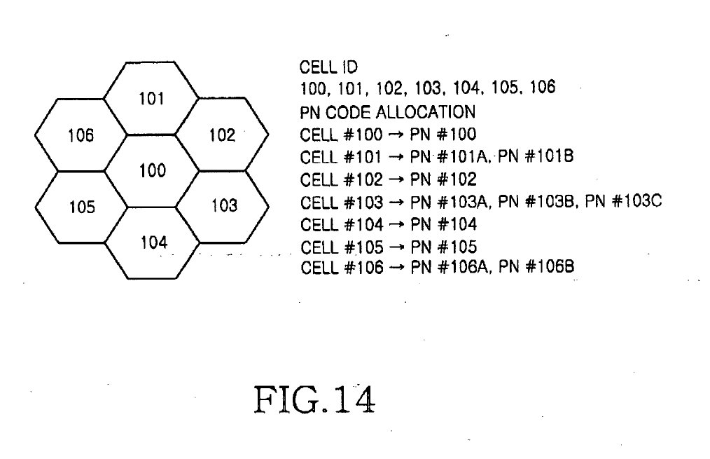

FIG. 14 is a diagram illustrating a method for allocating PN codes for ranging in a multicell configuration according to an embodiment of the present invention. Referring to FIG. 14, the OFDM/OFDMA communication system includes a plurality of cells, for example, a cell 100 to a cell 106. That is, a plurality of subscriber stations belonging to each cell region communicate with a particular base station, and if one or more subscriber stations among the plurality of subscriber stations move to a neighbor cell, the one or more subscriber stations are handed over to the neighbor cell to continue the communication.

According to the present invention, in order to increase a frequency reuse ratio by removing signal interference in a cell where respective subscriber stations are located and signal interference between cells, at least one predetermined PN code is allocated to each cell. For example, PN #100 is allocated to the cell #100, PN #101A and PN #101B are allocated to the cell #101, PN #102 is allocated to the cell #102, PN #103A, PN #103B, and PN #103C are allocated to the cell #103, PN #104 is allocated to the cell #104, PN #105 is allocated to the cell #105, and PN #106A and PN #106B are allocated to the cell #106.

In the foregoing example, the cell #101 is allocated two PN codes because the number of required codes is large as a large number of subscriber stations are connected to the corresponding cell. The cell #103 and the cell #106 are also allocated a plurality of PN codes for the same reasons. That is, assuming that N Walsh codes can be combined with one PN code, if the number of subscriber stations connected to the particular cell exceeds N, the PN code is additionally required. For example, assuming that the number of available Walsh codes is 10, if the number of subscriber stations connected to a particular cell is 54, the number of PN codes allocated to the corresponding cell must be 6 (i.e., PN #101A to PN #101F).

The base stations include information on the PN code separately allocated to each base station in a downlink (DL)-MAP message, and transmit the DL-MAP message to respective subscriber stations connected to the corresponding base station. The subscriber stations receiving the DL-MAP message detect possible base station code information from the received DL-MAP message, and use the detected base station code information in a base station ranging signal modulation procedure, which will be described in more detail herein below.

Upon detecting a received ranging signal, the base station previously knowing information on PN codes for neighbor base stations, uses the information in detecting ranging signals transmitted when subscriber stations connected to the neighbor base stations are handed over to the base station. As a result, the base station automatically recognizes a current base station of subscriber stations desiring to be handed over to the base station from neighbor base stations.

In addition, by using the PN codes separately allocated to base stations, it is possible to remove signal interference between ranging signals transmitted by subscriber stations transmitting periodic ranging signals for initial radio access and periodic synchronization time error compensation to the cell, and by subscriber stations connected to a neighbor base station.

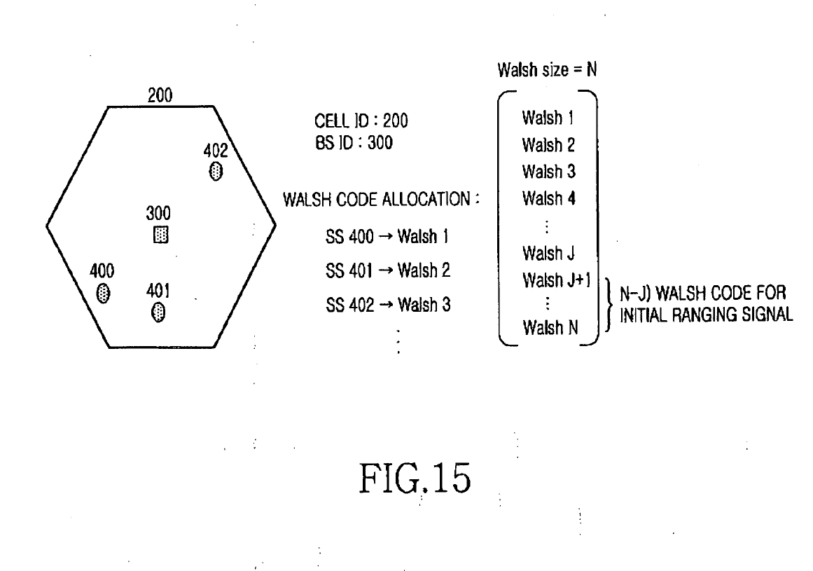

FIG. 15 is a diagram illustrating a method for allocating Walsh codes for ranging to subscriber stations in the same cell according to an embodiment of the present invention. Referring to FIG. 15, it is assumed that a cell ID is #200, a base station ID is #300, and 3 subscriber stations #400, #401, and #402 are connected to the cell. Because the number of available Walsh codes per PN code is N, Walsh #1 (or Walsh code #1) can be allocated to the subscriber station #400, Walsh #2 can be allocated to the subscriber station #401, and Walsh #3 can be allocated to the subscriber station #402.

It is preferable to set a length of the Walsh code such that the Walsh code has the same length as the PN code. In addition, some of the Walsh codes are reserved without being allocated to particular subscriber stations. As a result, unspecified subscriber stations can use them for initial ranging. For example, if there are N available Walsh codes of a length N, Walsh #1 to Walsh #J (where J<N) are allocated for configuration of ranging codes for the subscriber stations, and Walsh #(J+1) to Walsh #N are allocated for configuration of ranging codes for unspecified subscriber stations for initial ranging signals.

More specifically, in the OFDMA uplink system, if cells (or base stations) commonly use Walsh codes of the same length as ranging codes and a length of the Walsh codes is N, a length of the PN codes described in connection with FIG. 14 is also set to N. Because the Walsh codes are orthogonal with each other, no signal interference occurs between ranging codes used in the same cell.

In addition, the same number of Walsh codes can be divided for each cell according to use of ranging codes. For example, a subscriber station desiring an initial radio access can randomly select one of (N-J) predetermined Walsh codes and use it as an initial ranging code. Among N Walsh codes, the remaining J Walsh codes can be used as periodic ranging codes and bandwidth request ranging codes after radio access of the subscriber station. The J periodic ranging and bandwidth request ranging codes are allocated to subscriber stations by a base station in order to prevent code collision caused by using the same codes between subscriber stations, occurring during subscriber station identification and random code selection.

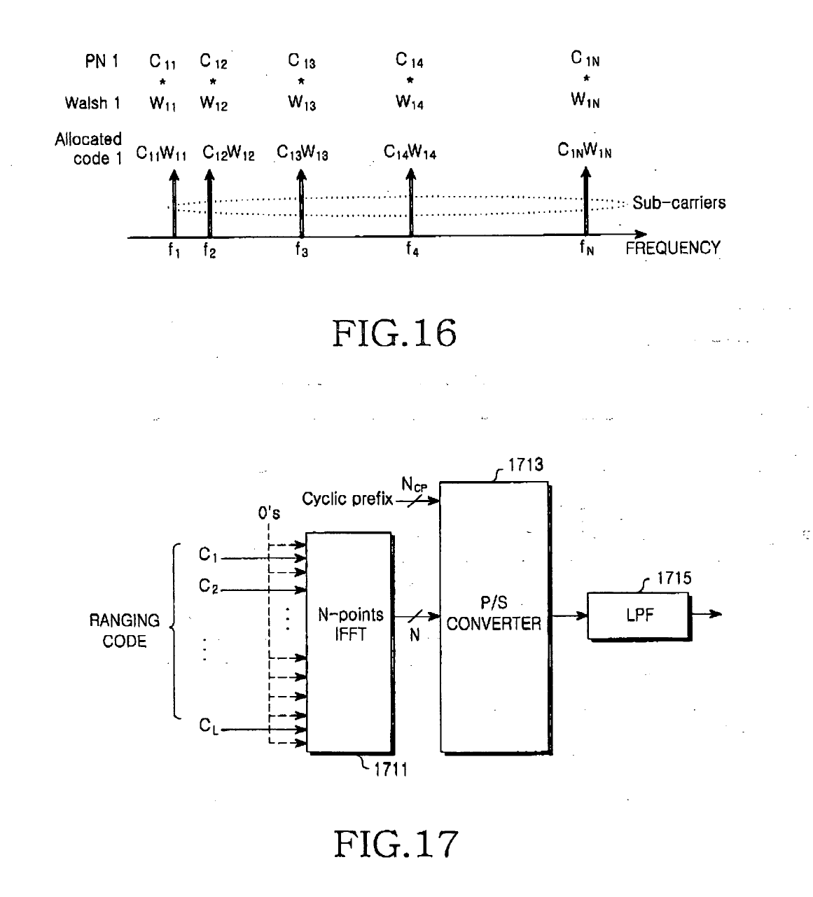

FIG. 16 is a diagram illustrating a method for allocating new unique ranging codes to respective subscriber stations according to an embodiment of the present invention. Referring to FIG. 16, ranging codes separately allocated to subscriber stations are actually generated by multiplying PN codes as described in connection with FIG. 14, with Walsh codes as described in connection with FIG. 15, on a chip-by-chip basis.

It is assumed that the number of the PN codes is K and the number of the Walsh codes is M. Therefore, the number of available ranging codes becomes K×M. Because the ranging codes are generated through bit operation between codes, a length of the newly generated ranging codes is equal to the length of the PN codes or the Walsh codes. For example, if a PN code allocated to the base station is defined as PN #1, the PN chip is represented by a 1-by-N vector of [C₁₁C₁₂C₁₃C₁₄ . . . C_{1N}], a selected particular Walsh code is defined as Walsh #1, and the Walsh chip is represented by a 1-by-N vector of [W₁₁W₁₂W₁₃W₁₄ . . . W_{1N}], then a ranging code obtained through multiplication between the chips is determined by a 1-by-N vector of [C₁₁W₁₁C₁₂W₁₂ C₁₃W₁₃ . . . C_{1N}W_{1N}].

The values separately calculated for the chips are allocated to a plurality of subcarriers allocated for transmitting ranging codes. For example, for inverse fast Fourier transform (IFFT) conversion, a result of C₁₁*W₁₁ is allocated to a subcarrier f₁, a result of C₁₂*W₁₂ is allocated to a subcarrier f₂, a result of C₁₃*W₁₃ is allocated to a subcarrier f₃, a result of C₁₄*W₁₄ is allocated to a subcarrier f₄, . . . , and a result of C_{1N}*W_{1N} is allocated to a subcarrier f_{N}. If a length of the generated ranging codes is N, the number of subcarriers included in a ranging subchannel is also N, and each of the subcarriers modulates code chips of the ranging codes.

FIG. 17 is a block diagram illustrating a subscriber station transmission apparatus for modulating ranging signals according to an embodiment of the present invention. Referring to FIG. 17, a transmission apparatus in a subscriber station for transmitting ranging codes determined in the methods as described above in conjunction with FIGS. 14 to 16 includes an N-point IFFT block 1711, a parallel-to-serial (P/S) converter 1713, and a low-pass filter (LPF) 1715.

The length-N ranging codes mapped to respective subcarriers in FIG. 16 are input to the N-point IFFT block 1711. If it is assumed that the number of input points of the IFFT block 1711 is N and a length of the ranging codes is L, then the length-L ranging codes are input to L selected points among the N input points of the N-point IFFT block 1711. The ranging codes IFFT-converted by the N-point IFFT block 1711 are parallel-to-serial converted by the parallel-to-serial converter 1713, and then output to the low-pass filter 1715. The converted ranging codes are low-pass filtered by the low-pass filter 1715, and transmitted to a base station through an RF processor (not shown) and an antenna (not shown).

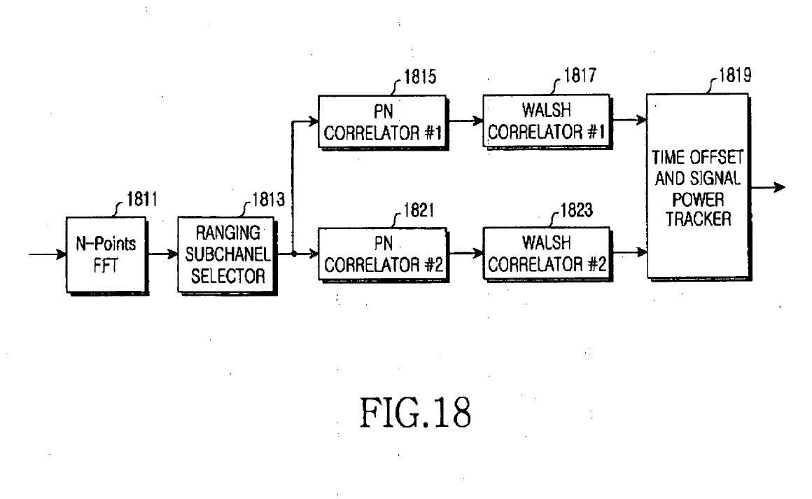

FIG. 18 is a block diagram illustrating a base station reception apparatus for detecting ranging signals according to an embodiment of the present invention. Referring to FIG. 18, the base station reception apparatus for receiving and demodulating ranging codes transmitted from subscriber stations includes an N-point FFT block 1811, a ranging subchannel selector 1813, first and second PN correlators 1815 and 1821, first and second Walsh correlators 1817 and 1823, and a time offset/signal power tracker 1819.

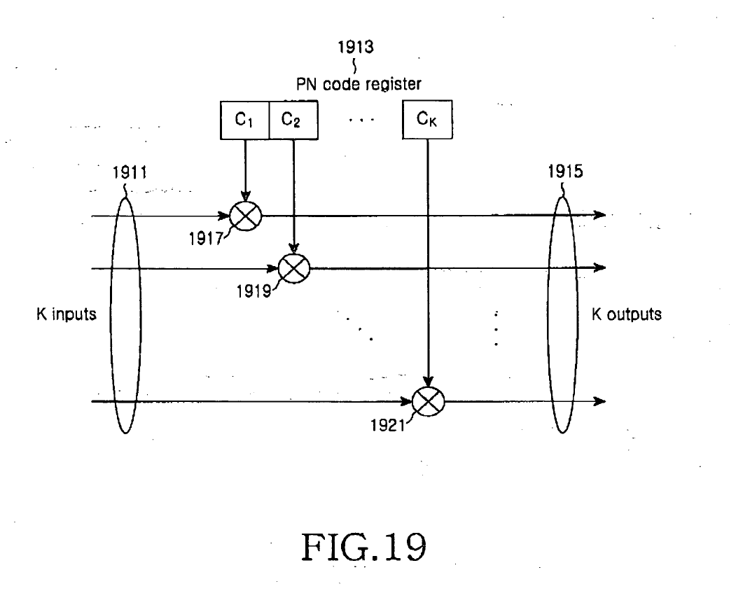

The base station receiving a ranging signal transmitted from the subscriber station illustrated in FIG. 17 removes a cyclic prefix from the received ranging signal, and FFT-converts the cyclic prefix-removed ranging signal into N samples through the N-point FFT block 1811. The FFT-converted output samples correspond to a signal in a frequency domain, and the N output subcarriers are input to the ranging subchannel selector 1813. The ranging subchannel selector 1813 selects only the samples corresponding to frequency positions of subcarriers constituting a ranging subchannel, and outputs the selected subcarriers for ranging to the first PN correlator 1815 or the second PN correlator 1821, according to their use. For example, the first PN correlator 1815 uses a PN code allocated to the corresponding base station, and the second PN correlator 1821 uses a PN code allocated to a neighbor base station. Therefore, ranging signals transmitted from subscriber stations connected to the corresponding base station are processed by the first PN correlator 1815, and ranging signals transmitted from subscriber stations belonging to neighbor base stations to the neighbor subscriber stations for handover are processed by the second PN correlator 1821. A detailed structure of the first and second PN correlators 1815 and 1821 will be described herein below with reference to FIG. 19.

The first PN correlator 1815 and the second PN correlator 1821 detect ranging signals transmitted by subscriber stations connected to the corresponding base station through a PN code allocated to the corresponding base station, using the allocated PN code. That is, ranging codes transmitted from a plurality of subscriber stations of neighbor base station are filtered by the PN correlators.

The signals output from the first and second PN correlators 1815 and 1821 are input to the first and second Walsh correlators 1817 and 1823. Thereafter, the first and second Walsh correlators 1817 and 1823 distinguish the subscriber stations. That is, the base station can identify subscriber stations that transmitted the ranging signals, by detecting Walsh codes separately allocated to the subscriber stations. After the identification of subscriber stations, the base station performs ranging by tracking time offset and signal power through the time offset/signal power tracker 1819.

FIG. 19 is a diagram illustrating a detailed structure of a PN correlator according to an embodiment of the present invention. Referring to FIG. 19, the PN correlator includes a PN code register 1913 for storing a PN code of a length K, and K multipliers 1917 to 1921 for multiplying respective values of the PN code by an input signal. For example, ranging codes 1911, which are allocated to K subcarriers, are multiplied by PN code values stored in the PN code registers 1913. The PN code values stored in the PN code register 1913, as described above, are PN code values that have been previously set for corresponding base stations. Therefore, it is possible to detect only a ranging code transmitted as the same PN code by detecting a correlation between the stored PN code values and the received ranging codes 1911.

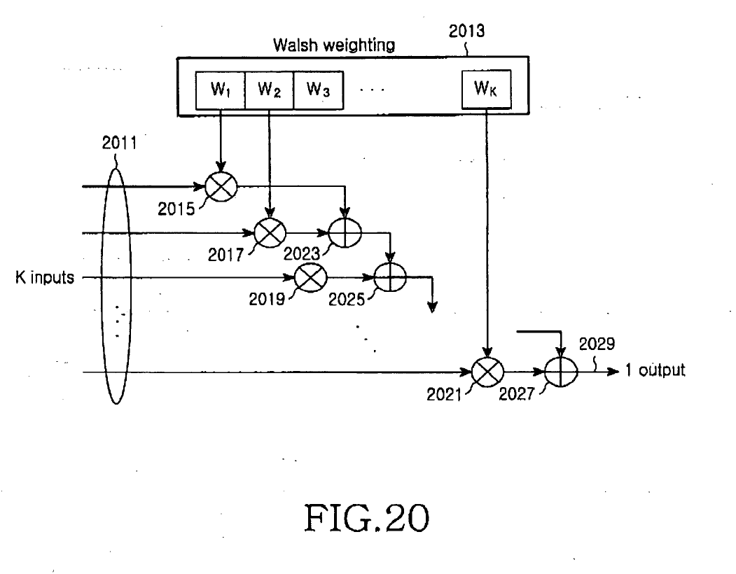

FIG. 20 is a diagram illustrating a Walsh correlator according to an embodiment of the present invention. Referring to FIG. 20, the Walsh correlator includes a Walsh weighting processor 2013 for storing K Walsh weights, a plurality of multipliers 2015 to 2021, and a plurality of adders 2023 to 2027. The Walsh correlator detects a correlation between Walsh codes by receiving input values 2011 provided from the PN correlator illustrated in FIG. 19.

The K input values 2011 received at the Walsh code correlator through PN code correlation detection are multiplied by weight constants from the Walsh weighting processor 2013, and the resultant multiplication values are added as illustrated in FIG. 20, thereby outputting a final output value 2029.

If the Walsh correlator corresponds to the first Walsh correlator 1817 in FIG. 18, the K weight values from the Walsh weighting processor 2013 correspond to a code randomly selected from all Walsh codes. However if the Walsh correlator corresponds to the second Walsh correlator 1823 in FIG. 18, the K weight values from the Walsh weighting processor 2013 correspond to one of the codes classified for periodic ranging and bandwidth request ranging among the Walsh codes. In addition, respective constants from the Walsh weighting processor 2013 can be implemented with weighted Walsh codes obtained by multiplying the corresponding Walsh code chip by a particular constant considering, for example, a channel frequency response.

It is preferable that the proposed operation of separately allocating ranging codes to subscriber stations and allocating ranging transmission times should be performed by the base station. According to the present invention, the method for allocating ranging transmission times differentiates transmission times of the ranging signals such that during reception of the ranging signals, the base station can reduce interference between ranging signals that occurs as a result of a multipath channel environment. Accordingly, a capability of detecting the ranging signals can be increased.

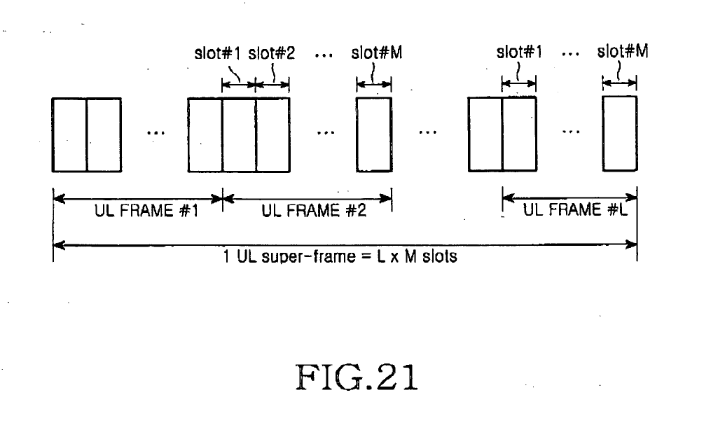

FIG. 21 is a diagram illustrating a method for scheduling transmission of ranging signals of subscriber stations by a base station according to an embodiment of the present invention. As described in connection with FIG. 17, the IFFT-converted ranging code is transmitted for one slot period. Conventionally, when the subscriber stations desire to transmit ranging codes in the manner described above, the subscriber stations transmit the ranging codes for a slot period randomly selected from ranging code transmission periods. However, according to the present invention, because unique ranging codes are allocated to the subscriber stations, it is possible for the base station to select each subscriber station and schedule a transmission time of the ranging code. That is, according to the present invention, by reducing collisions between signals by grouping ranging signal transmission times in a same cell in such a multipath channel environment, the base station increases a capability of receiving and detecting ranging signals.

Referring to FIG. 21, the ranging signal transmission can be performed by a subscriber station once every uplink (UL) superframe, which includes L uplink frames. A parameter L for determining a size of the uplink superframe can be set such that it has a different integer for each base station.

Each of L frames included in the uplink superframe has M ranging slots. Here, it is preferable that the parameter M is set to the same integer for each base station. For example, if one uplink superframe has M×L slots available for ranging signal transmission, each subscriber station is allocated only one slot from the base station and performs periodic ranging. By distributing transmission periods of ranging signals by subscriber stations as described above, it is possible to reduce the entire interference level, even though signal interference with other ranging signals occurs in a frequency-selective radio channel environment.

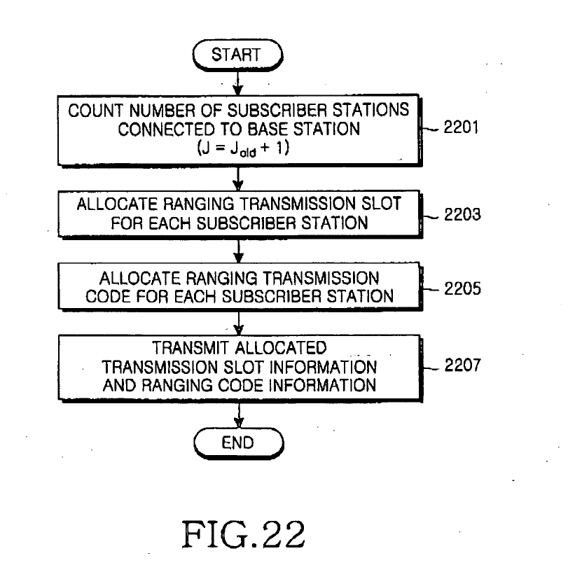

FIG. 22 is a flowchart illustrating a transmission procedure of a base station according to an embodiment of the present invention. Referring to FIG. 22, each base station stores information on the number of subscriber stations connected thereto in a predetermined register. In step 2201, if there is a subscriber station newly connected to the base station, the base station updates the number of subscriber stations (J=J_{old}+1, where J is the number of all subscriber stations connected to the corresponding base station).

After updating the number of subscriber stations, the base station allocates ranging slots for the subscriber stations in step 2203. The ranging slots separately allocated to the subscriber stations can be expressed as shown in Equation (1),
#of slot=J mod ML (1)
where M and L denote the number of frames per superframe and the number of slots per frame, respectively.

After allocating ranging transmission slots for the subscriber stations, the base station allocates Walsh codes identifying ranging codes for the subscriber stations in step 2205. A method for allocating the Walsh codes can be implemented by Equation (2).

$$£ of Walsh = Fix ( \frac{J}{ML} ) \qquad ( 2 )$$

In Equation (2), Fix(x) projects an ‘x’ value into an integer nearest to ‘0’. That is, the function Fix is a function of discarding a value below a decimal point of the ‘x’ value and taking an integer value.

Thereafter, in step 2207, the base station includes the allocated Walsh code and transmission slot information in a downlink broadcasting message such as UL-MAP, and transmits the message to the corresponding subscriber station.

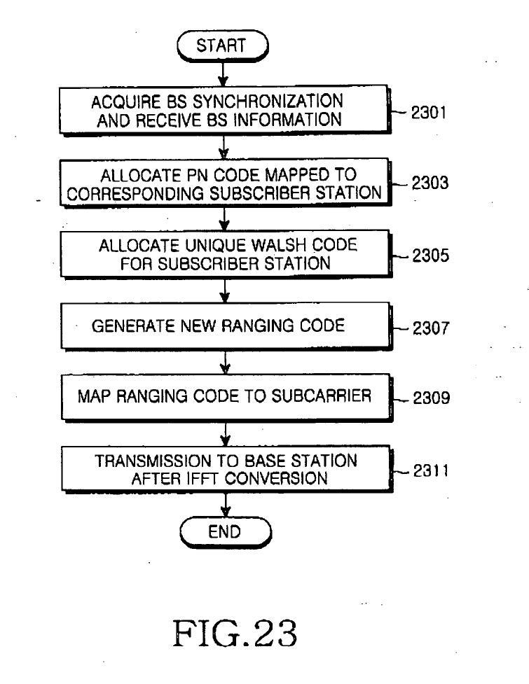

FIG. 23 is a flowchart illustrating a procedure for generating and transmitting a ranging code by a subscriber station according to an embodiment of the present invention. Referring to FIG. 23, in step 2301, the subscriber station acquires synchronization with a base station through an initial ranging procedure, and receives information on the base station. In step 2303, the subscriber station is allocated a PN code, which was previously set in a corresponding base station, from the information received from the base station, and then proceeds to step 2305. In step 2305, the subscriber station is allocated its own unique Walsh code from the base station. In step 2307, the subscriber station generates a new ranging code from the allocated PN code and Walsh code in the above-described method. In step 2309, the subscriber station maps the generated ranging code to an allocated subcarrier, and in step 2311, the subscriber station IFFT-converts the ranging codes mapped to each subcarrier, and transmits the IFFT-converted ranging codes to the base station at a predetermined time.

As can be understood from the foregoing description, a base station according to the present invention improves ranging reception detection performance, thereby reducing an initial radio access time and a handover delay time. In addition, codes for base station identification and codes for subscriber station identification are separately allocated, thereby decreasing the amount of ranging signal detection by the base station. Moreover, when a new cell must be added due to an abrupt increase in number of subscriber stations included in the existing cell, it is possible to easily set up a cell plan by allocating at least one PN code to a new cell. In addition, when a combination of a PN code and a Walsh code is used as a ranging code, it is possible to generate an increased number of available codes, as compared to when only the PN code is used as a ranging code.

While the present invention has been shown and described with reference to certain preferred embodiments thereof, it will be understood by those skilled in the art that various changes in form and details may be made therein without departing from the spirit and scope of the present invention as defined by the appended claims.

1. A method for transmitting ranging information from at least one base station to a subscriber station comprising the steps of:
transmitting first code information for generating a ranging code by the subscriber station, wherein the first code information is different from first code information of a neighboring base station; and
transmitting second code information for generating the ranging code by the subscriber station, wherein the second code information is different from second code information of a second subscriber station with a cell region of the base station.

2. The method of claim 1, wherein the first code information is a pseudo noise (PN) sequence.

3. The method of claim 1, wherein the second code information is a Walsh code.

4. The method of claim 3, wherein at least one Walsh code in the second code information is for initial ranging of the subscriber station.

5. The method of claim 1, wherein the ranging information is transmitted to the subscriber station through a downlink-MAP (DL-MAP) message transmitted by the base station.

6. The method of claim 1, wherein the base station broadcasts a transmission time of the ranging signal through an uplink-MAP (UL-MAP) message.

7. The method of claim 6, wherein a modulation method and coding information for the ranging signal are transmitted through an uplink channel descript (UCD) message from the base station.

8. The method of claim 1, further comprising a step of receiving the ranging code generated from the subscriber station by combining the first code information with the second code information.

9. A method for transmitting ranging information from at least one base station to a subscriber station and generating a ranging code by the subscriber station using received ranging information comprising the steps of:
receiving first code information from the base station, wherein the first code information is different from first code information of a neighboring base station;
receiving second code information from the base station, wherein the second code information is different from second code information of a second subscriber station with a cell region of the base station; and
generating a new ranging code by combining the first code information with the second code information.

10. The method of claim 9, further comprising the step of mapping the generated new ranging code to a previously allocated subcarrier before transmission.

11. The method of claim 9, wherein the first code information is a pseudo noise (PN) sequence.

12. The method of claim 9, wherein the second code information is a Walsh code.

13. The method of claim 9, wherein the ranging code is generated by multiplying the first code information by the second code information.

14. The method of claim 9, wherein the subscriber station divides uplink transmission slot periods allocated for transmitting the ranging code in a corresponding cell into a plurality of transmission groups, allocates the transmission groups such that at least one subscriber station transmitting the ranging code are uniformly distributed to the transmission groups, and transmits the ranging code in the allocated transmission groups.

15. The method of claim 9, wherein the ranging information is transmitted to the subscriber station through a downlink-MAP (DL-MAP) message transmitted by the base station.

16. The method of claim 9, wherein the base station broadcast a transmission time of the ranging information through an uplink MAP (UL-MAP) message.

17. The method of claim 9, wherein a modulation method and coding information for the ranging code are transmitted through an uplink channel descript (UCD) message from the base station.

18. An apparatus for transmitting ranging information from at least one base station to subscriber station and generating a ranging code by a subscriber station using received ranging information, comprising:
a first code generator for generating a first code using first code information received from the base station, wherein the first code information is different from first code information of a neighboring base station;
a second code generator for generating a second code using second code information received from the base station, wherein the second code information is different from second code information of a second subscriber station with a cell region of the base station; and
a ranging code generator for generating a new ranging code by combining the first code with the second code.

19. The apparatus of claim 18, further comprising a subcarrier mapper for mapping the generated ranging code to a previously allocated subcarrier.

20. The apparatus of claim 18, wherein the first code information is a pseudo noise (PN) sequence.

21. The apparatus of claim 20, wherein the PN sequence is a sequence for base station identification.

22. The apparatus of claim 18, wherein the second code information is a Walsh code.

23. The apparatus of claim 22, wherein the Walsh code is a code for identifying subscriber stations in a cell region.

24. The apparatus of claim 18, wherein the ranging code generator further comprises a multiplier for multiplying the first code by the second code.

25. The apparatus of claim 18, wherein the subscriber station divides uplink transmission slot periods allocated for transmitting the ranging signal in a corresponding cell into a plurality of transmission groups, allocates the transmission groups such that at least one subscriber station transmitting the ranging signal are uniformly distributed to the transmission groups, and transmits the ranging code in the allocated transmission groups.

26. The apparatus of claim 18, wherein the ranging information is transmitted to the subscriber station through a downlink-MAP (DL-MAP) message transmitted by the base station.

27. The apparatus of claim 18, wherein the base station broadcast a transmission time of the ranging information through an uplink MAP (UL-MAP) message.

28. The apparatus of claim 18, wherein a modulation method and coding information for the ranging signal are transmitted through an uplink channel descript (UCD) message from the base station.
